(19) United States
(12) Patent Application Publication
(10) Pub. No.: US 2024/0199223 A1
(43) Pub. Date: Jun. 20, 2024

(54) VEHICLE STARTUP USER INTERFACE

(71) Applicant: Skyryse, Inc., El Segundo, CA (US)

(72) Inventors: Christopher Camilo Cole, Santa Monica, CA (US); Gonzalo Javier Rey, Torrence, CA (US); Mark Daniel Groden, Marina del Rey, CA (US); Chaitanyakumar Vipulbhai Shah, Los Angeles, CA (US); Christina Marie Hicks, Santa Fe, NM (US)

(21) Appl. No.: 18/541,492

(22) Filed: Dec. 15, 2023

Related U.S. Application Data
(60) Provisional application No. 63/433,240, filed on Dec. 16, 2022.
(60) Provisional application No. 63/433,241, filed on Dec. 16, 2022.
(60) Provisional application No. 63/433,245, filed on Dec. 16, 2022.

(51) Int. Cl. B64D 43/00

(52) U.S. Cl. CPC B64D 43/00; B64C 29/00

(57) ABSTRACT

A vehicle control and interface system described herein assists an operator of an aerial vehicle with the operation of an aerial vehicle, including preparing for flight. A vehicle control and interface system partially or fully automates a procedure for preparing an aerial vehicle for flight, which is referred to herein as engine startup. The engine startup can include safety and accuracy verifications before and after starting an aerial vehicle's engine. The system can check engine parameters (e.g., turbine rotational speeds, engine torque, engine oil pressure), cabin parameters (e.g., a status of seat belts or a current weight of passengers and cargo within the cabin), fuel load, an area around the aerial vehicle (e.g., using cameras to determine that the area is clear of objects before takeoff), any suitable measurement that impacts safe aerial vehicle operations, or a combination thereof.

### CROSS REFERENCE TO RELATED APPLICATIONS

This application claims the benefit of priority to U.S. Provisional Application Nos. 63/433,240, 63/433,241, and 63/433,245, filed Dec. 16, 2022, the disclosure of which are hereby incorporated by reference in their entirety.

### TECHNICAL FIELD

The disclosure generally relates to the field of vehicle control systems, and particularly to startup interfaces for aerial vehicles.

### BACKGROUND

Vehicle control and interface systems, such as control systems for aerial vehicles (e.g., rotorcraft or fixed wing aerial vehicle), often require specialized knowledge and training for operation by a human operator. The specialized knowledge and training is necessitated, for instance, by the complexity of the control systems and safety requirements of the corresponding vehicles. Moreover, vehicle control and interface systems are specifically designed for types or versions of certain vehicles. For example, specific rotorcraft and fixed wing aerial vehicle control systems are individually designed for their respective contexts. As such, even those trained to operate one vehicle control system may be unable to operate another control system for the same or similar type of vehicle without additional training. Although some conventional vehicle control systems provide processes for partially or fully automated vehicle control, such systems are still designed for individual vehicle contexts.

Even before an aerial vehicle leaves the ground, operating the aerial vehicle can be inaccessible to a person who has not received pilot training. The process to prepare an aerial vehicle for flight has many, complicated steps that are typically known only to pilots with specialized training. Even a relatively simple aerial vehicle to operate can have over one hundred items to check before flying. An aerial vehicle's operator must be familiar with many different controls in a cockpit to operate a single aerial vehicle, let alone an aerial vehicle from a different manufacturer or a different type of aerial vehicle.

Furthermore, an aerial vehicle's physical interface (e.g., knobs, switches, buttons, etc.) may remain fixed while an aerial vehicle's software can update and improve. As the software evolves but the hardware that controls the software becomes fixed, software functionality is either limited by the buttons available to control it or the buttons begin to become outdated as they no longer have purpose in newer software updates.

Additionally, the control and interface systems for aerial vehicles are often physical interfaces are not customizable once manufactured and placed in a cockpit, the design of which is often tailored to an average body type. Thus, conventional vehicle control and interface systems can make operation difficult or even preclusive for certain operators whose physical features do not subscribe to an average body type.

### BRIEF DESCRIPTION OF DRAWINGS

The disclosed embodiments have other advantages and features which will be more readily apparent from the detailed description, the appended claims, and the accompanying figures (or drawings). A brief introduction of the figures is below.

FIG. 1 illustrates a vehicle control and interface system, in accordance with one or more embodiments.

FIG. 2 illustrates one embodiment of a schematic diagram for a universal avionics control router in a redundant configuration, in accordance with one or more embodiments.

FIG. 3 illustrates a configuration for a set of universal vehicle control interfaces in a vehicle, in accordance with one or more embodiments.

FIG. 4 shows a graphical user interface (GUI) generated by a vehicle control and interface system at an electronic display of the aerial vehicle before starting an engine of the aerial vehicle, in accordance with one or more embodiments.

FIG. 5 is a depiction of a navigation configuration interface of the GUI of FIG. 4 in greater detail, in accordance with one or more embodiments.

FIG. 6 shows an aerial vehicle and trip configuration interface and a navigation configuration interface of the GUI of FIG. 4 during an engine startup performed by a vehicle control and interface system, in accordance with one or more embodiments.

FIG. 7 is a flowchart of a process for determining an aerial vehicle is ready for flight through automated engine startup checks, in accordance with one or more embodiments.

FIG. 8 shows a navigation configuration interface of the GUI of FIG. 4 during a selection of a COM frequency, in accordance with one or more embodiments.

FIG. 9 shows configurations of a navigation configuration interface of the GUI of FIG. 4 when selecting a speed of the aerial vehicle, in accordance with one or more embodiments.

FIG. 10 shows configurations of a trip visualization interface and a navigation visualization interface of the GUI of FIG. 4 as the aerial vehicle is beginning takeoff, in accordance with one or more embodiments.

FIG. 11 shows a navigation visualization interface and a navigation configuration interface of the GUI of FIG. 4 during navigation of an aerial vehicle in flight, in accordance with one or more embodiments.

FIG. 12 shows a flight display in the navigation visualization interface of the GUI of FIG. 4 during flight, in accordance with one or more embodiments.

FIG. 13 shows a GUI generated by the vehicle control and interface system at an electronic display of an aerial vehicle during flight, in accordance with at least one embodiment.

FIG. 14 shows the GUI of FIG. 13 with an additional trip visualization interface 1400, in accordance with at least one embodiment.

FIG. 15 shows a navigation visualization interface of the GUI of FIG. 4 displaying a flight navigation instrument and an aerial vehicle and trip configuration interface displaying trip information, in accordance with one or more embodiments.

FIG. 16 shows an aerial vehicle and trip configuration interface of the GUI of FIG. 4 during a search for a travel destination, in accordance with one or more embodiments.

FIG. 17 shows aerial vehicle information displayed at an aerial vehicle and trip configuration interface of the GUI of FIG. 4, in accordance with one or more embodiments.

FIG. 18 shows cabin information displayed at an aerial vehicle and trip configuration interface of the GUI of FIG. 4, in accordance with one or more embodiments.

FIG. 19 shows the GUI of FIG. 4 during an emergency landing, in accordance with one or more embodiments.

FIG. 20 is a flowchart of a process for generating and updating a GUI for controlling aerial vehicle navigation using finger gestures, in accordance with one or more embodiments.

FIG. 21 shows a front view of a stowed position of a touch screen interface of a movable control interface, in accordance with one or more embodiments.

FIG. 22 shows an isometric view of a movable control interface having a touch screen interface that is raised from a stowed position, in accordance with one or more embodiments.

FIG. 23 shows a front view of a movable control interface having a touch screen interface that is raised and extended from a stowed position, in accordance with one or more embodiments.

FIG. 24 shows an isometric view of a movable control interface having a touch screen interface that is raised and extended from a stowed position, in accordance with one or more embodiments.

FIG. 25 shows a front view of a movable control interface having a touch screen interface that is raised and extended, in accordance with one or more embodiments.

FIG. 26 shows a rear view of a movable control interface having a touch screen interface that is extended into an intermediary position, in accordance with one or more embodiments.

FIG. 27 shows an isometric view of a movable control interface having a touch screen interface that is in an in-flight position, in accordance with one or more embodiments.

FIG. 28 is a flowchart of a process for operating a movable control interface of the vehicle control and interface system, in accordance with one or more embodiments.

FIG. 29 is a flowchart of a process for controlling an aerial vehicle based on user gestures, in accordance with at least one embodiment.

FIG. 30 is a block diagram illustrating one example embodiment of components of an example machine able to read instructions from a machine-readable medium and execute them in a processor (or controller).

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Configuration Overview

Embodiments of a disclosed system, method and a non-transitory computer readable storage medium include automated assistance for engine startup, navigation control, and movement of an electrical display screen through which operations can be controlled (e.g., in small fly-by-wire vehicles). A vehicle control and interface system partially or fully automates a procedure for preparing an aerial vehicle for flight, which is referred to herein as engine startup. The engine startup can include safety and accuracy verifications before and after starting an aerial vehicle's engine. The system can check engine parameters (e.g., turbine rotational speeds, engine torque, engine oil pressure, or engine oil temperature), cabin parameters (e.g., a status of seat belts or a current weight of passengers and cargo within the cabin), fuel load, an area around the aerial vehicle (e.g., using cameras to determine that the area is clear of objects or people before takeoff), any suitable measurement that impacts safe aerial vehicle operations, or a combination thereof. The system may determine that the measurements met accuracy criteria before acting upon determinations involving the measurements. For example, before determining that measured pre-start engine parameters satisfy operation criteria to start an engine of the aerial vehicle, the system may use multiple sensors to produce redundant measurements for comparison or use a voting system for determining whether one of the flight control computers is malfunctioning.

The vehicle control and interface system is configured to generate and display (and/or provide (e.g., transmit) for display) a graphical user interface (GUI) through which an operator can specify navigation instructions (e.g., using finger gestures on a touch screen interface). The vehicle and control interface system may further be configured to cause instruction of actuators of the aerial vehicle based on the received navigation instructions (e.g., sending the gesture commands to a flight control computer (FCC) to interpret, and the FCC instructs the actuators based on the received gesture input). Additionally, the vehicle and control and interface system may be configured to update the GUI to show, via a digital avatar, the changing orientation of the aerial vehicle in substantially real time. The GUI may be generated to reduce mental strain expended by a non-specialized operator (e.g., a person who is not a trained pilot) by, for example, using simplified representations of the aerial vehicle's environment. Simplified representations of the environment may, for example, omit depictions of objects at the surface of the earth or natural features at the earth's surface (e.g., rivers, canyons, mountains, etc.). In another example, the GUI may assist in the comprehensibility of a flight display by generating attitude indicators that show the aerial vehicle's orientation relative to a fixed horizon line. Electronically generated control interfaces enable the vehicle control and interface system to provide dynamic and customizable controls that can be adapted for different aerial vehicle types, manufacturers, and different software. An electronically generated control interface may also be referred to as an Electronic Flight Instrument System (EFIS).

A movable control interface of the vehicle control and interface system adapts aerial vehicle operation to varying physical features of operators by enabling the operator to choose a position of a touch screen interface (e.g., a height of the screen, distance in front of the pilot's seat, etc.) that is adjustable using a mechanical arm. The movable control interface can move a touch screen interface from a stowed position (e.g., away from a pilot seat and proximal to a dashboard towards the front of the cockpit) to an in-flight position (e.g., towards the pilot seat in a position that encourages an ergonomic position of the operator to reach the touch screen interface without straining their shoulder).

The disclosed systems may increase vehicle safety by providing a full fly-by-wire (FBW) architecture with multiple redundancy. The systems may enable retrofitting an existing vehicle with an autonomous agent (and/or enable autonomous agent certification) by providing a sufficient degree of control and power redundancy to autonomous agents. Additionally, such systems may provide distributed redundant control modules about the vehicle, thereby providing increased resilience of power systems (and autonomous agents alike) to EMI interference, electrical failure, lightning, bird-strike, mechanical impact, internal/external fluid spills, and other localized issues.

The disclosed systems may enable autonomous and/or augmented control schemes without relying on the pilot (or other operator) as a backup in the event of power failure. Accordingly, such systems may fully eliminate the ‘direct human control’ layer because augmented modes are persistent in the event of multiple failures, including power failures, (e.g., augmented control modes can rely on triply-redundant, continuous backup power). In a specific example, an aerial vehicle is configured to autonomously land (and/or augment landing) even with generator failure and/or no primary electrical power supply to the aerial vehicle. In a second specific example, each of three flight control computers is capable of providing fully augmented and/or autonomous control (or landing). Such systems may allow transportation providers and users to decrease training for ‘direct’ or ‘manual’ modes (where they are the backup: and relied upon to provide mechanical actuation inputs). Such systems may further reduce the cognitive load on pilots in safety-critical and/or stressful situations, since they can rely on persistent augmentation during all periods of operation.

The disclosed systems may reduce vehicle mass and/or cost (e.g., especially when compared to equivalently redundant systems). By co-locating multiple flight critical components and functions within a single housing, systems can reduce the cable length, minimize the number of distinct connections required for vehicle integration (thereby improving ease of assembly), and allow use of less expensive sensors and/or processors without an electronics bay (e.g., as individual components can often require unique electrical and/or environmental protections). Similarly, integration of the system in a vehicle can allow the vehicle to operate without (e.g., can allow physical removal of) various vehicle components necessary for manual flight, such as: hydraulic pumps, fluid lines, pilot-operated mechanical linkages, and/or any other suitable components. In some embodiments, modules can additionally enable after-market FBW integration on an existing vehicles while utilizing the existing electrical infrastructure, which can substantially decrease the overall cost of FBW solutions.

### Example Vehicle Control and Interface System

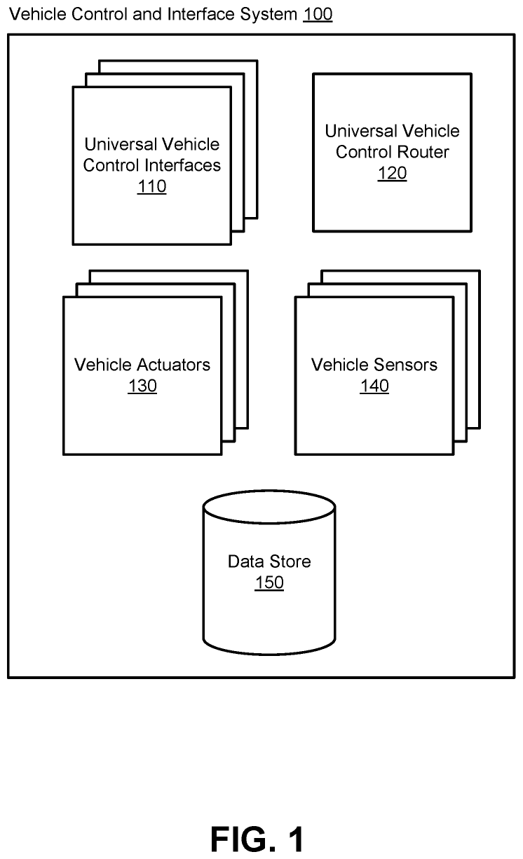

Figure (FIG. 1 illustrates a vehicle control and interface system 100, in accordance with one embodiment. In the example embodiment shown, vehicle control and interface system 100 includes one or more universal vehicle control interfaces 110, universal vehicle control router 120, one or more vehicle actuators 130, one or more vehicle sensors 140, and one or more data stores 150. In other embodiments, the vehicle control and interface system 100 may include different or additional elements. Furthermore, the functionality may be distributed among the elements in a different manner than described. The elements of FIG. 1 may include one or more computers that communicate via a network or other suitable communication method.

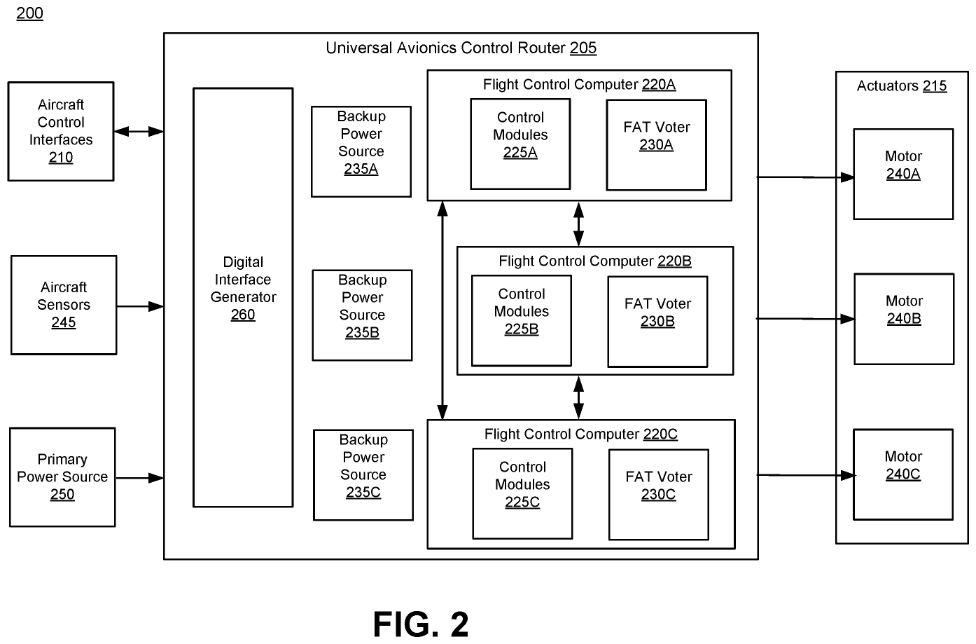

The vehicle control and interface system 100 may be integrated with various vehicles having different mechanical, hardware, or software components. For example, the vehicle control and interface system 100 may be integrated with vehicles such as fixed wing aerial vehicles (e.g., airplanes), rotorcraft (e.g., helicopters, multirotors), spacecraft, motor vehicles (e.g., automobiles), watercraft (e.g., power boats or submarines), or any other suitable vehicle. An aerial vehicle is a machine capable of flight such as airplanes, rotorcraft (e.g., helicopters and/or multi-rotor aerial vehicles), airships, etc. As described in greater detail below with reference to FIGS. 2-6, the vehicle control and interface system 100 is advantageously configured to receive inputs for requested operation of a particular vehicle via universal set of interfaces and the inputs to appropriate instructions for mechanical, hardware, or software components of the particular vehicle to achieve the requested operation. In doing so, the vehicle control and interface system 100 enables human operators to operate different vehicles using the same universal set of interfaces or inputs. By way of example, “universal” indicates that a feature of the vehicle control and interface system 100 may operate in a vehicle-agnostic manner. This allows for vehicle integration without necessarily having to design and configure vehicle specific customizations or reconfigurations in order to integrate the specific feature. Although universal features of the vehicle control and interface system 100 can function in a vehicle-agnostic manner, the universal features may still be configured for particular contexts. For example, the vehicle control or interface system 100 may receive or process inputs describing three-dimensional movements for vehicles that can move in three dimensions (e.g., aerial vehicle) and conversely may receive or process inputs describing two-dimensional movements for vehicles that can move in two dimensions (e.g., automobiles). One skilled in the art will appreciate that other context-dependent configurations of universal features of the vehicle control and interface system 100 are possible.

The universal vehicle control interfaces 110 are a set of universal interfaces configured to receive a set of universal vehicle control inputs to the vehicle control and interface system 100. The universal vehicle control interfaces 110 may include one or more digital user interfaces presented to an operator of a vehicle via one or more electronic displays. Additionally, or alternatively, the universal vehicle control interfaces 110 may include one or more hardware input devices, e.g., one or more control stick inceptors, such as side sticks, center sticks, throttles, cyclic controllers, or collective controllers. The universal vehicle control interfaces 110 receive universal vehicle control inputs requesting operation of a vehicle. In particular, the inputs received by the universal vehicle control interfaces 110 may describe a requested trajectory of the vehicle, such as to change a velocity of the vehicle in one or more dimensions or to change an orientation of the vehicle. Because the universal vehicle control inputs describe an intended trajectory of a vehicle directly rather than describing vehicle-specific precursor values for achieving the intended trajectory, such as vehicle attitude inputs (e.g., power, lift, pitch, roll yaw), the universal vehicle control inputs can be used to universally describe a trajectory of any vehicle. This is in contrast to existing systems where control inputs are received as vehicle-specific trajectory precursor values that are specific to the particular vehicle. Advantageously, any individual interface of the set of universal vehicle control interfaces 110 configured to receive universal vehicle control inputs can be used to completely control a trajectory of a vehicle. This is in contrast to conventional systems, where vehicle trajectory must be controlled using two or more interfaces or inceptors that correspond to different axes of movement or vehicle actuators. For instance, conventional rotorcraft systems include different cyclic (controlling pitch and roll), collective (controlling heave), and pedal (controlling yaw) inceptors. Similarly, conventional fixed-wing aerial vehicle systems include different stick or yoke (controlling pitch and role), power (controlling forward movement), and pedal (controlling yaw) inceptors.

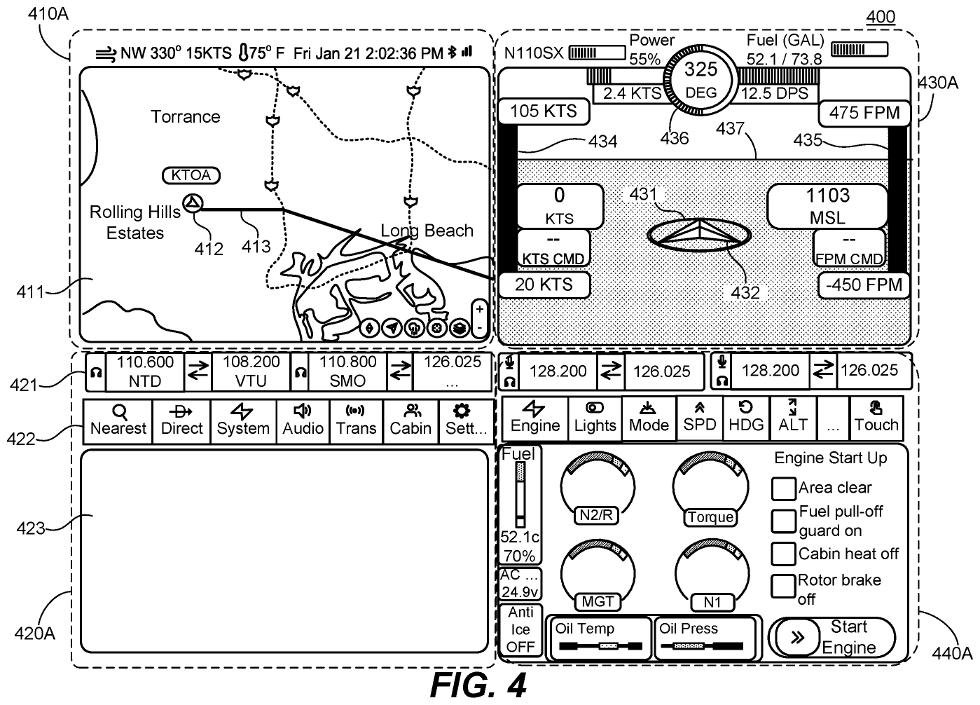

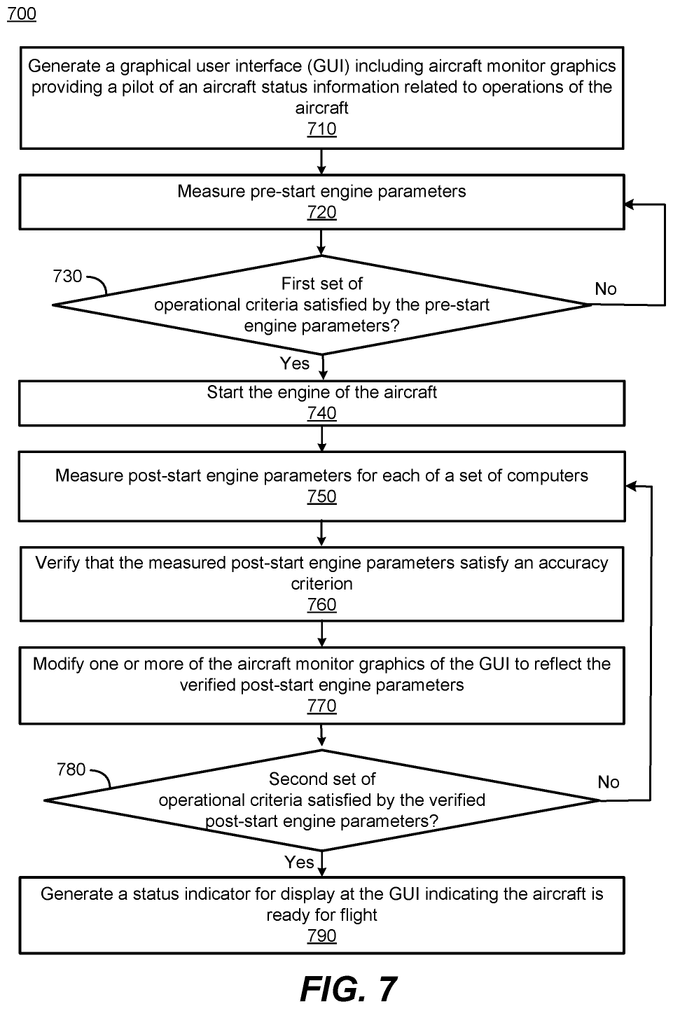

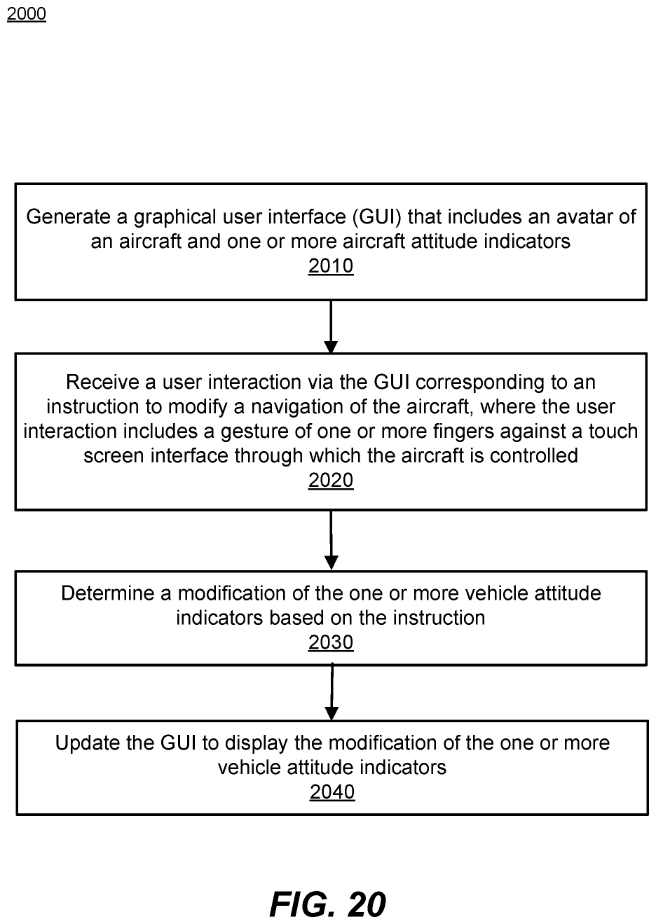

The universal vehicle control interfaces 110 may include one or more digital user interfaces (e.g., graphical user interfaces (GUIs)) presented to an operator of a vehicle via one or more electronic displays. The electronic displays of the universal vehicle control interfaces 110 may include displays that are partially or wholly touch screen interfaces. Examples of GUIs include an interface to prepare the vehicle for operation, an interface to control the navigation of the vehicle, an interface to end operation of the vehicle, any suitable interface for operating the vehicle, or a combination thereof. The GUIs may include user input controls that enable the user to control operation of the vehicle. In some embodiments, the universal vehicle control interfaces 110 include interfaces that provide feedback information to an operator of the vehicle. For instance, the universal vehicle control interfaces 110 may provide information describing a state of a vehicle integrated with the universal vehicle control interfaces 110 (e.g., engine startup checks, current vehicle speed, direction, orientation, location, etc.). Additionally, or alternatively, the universal vehicle control interfaces 110 may provide information to facilitate navigation or other operations of a vehicle, such as visualizations of maps, terrain, or other environmental features around the vehicle. Examples of GUIs of the universal vehicle control interfaces 110 are described in greater detail with reference to FIGS. 4-6 and FIGS. 8-17. Examples of processes for using GUIs of the universal vehicle control interfaces 110 are described with reference to FIGS. 7 and 20.

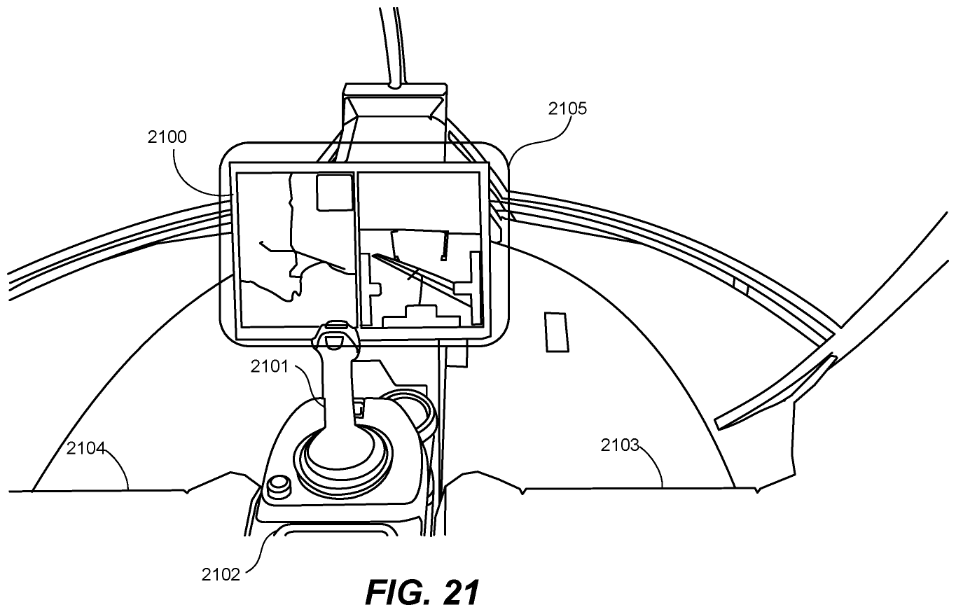

The universal vehicle control interfaces 110 may include a movable control interface enabling an operator of a vehicle to access an electronic display. The movable control interface may include an electronic display and a mechanical arm coupled to the electronic display. The electronic display may be a touch screen interface. The movable control interface may enable the operator to access both a touch screen interface and a mechanical controller stick simultaneously (i.e., performing both activities during at least one shared time). In particular, the movable control interface may be movable to change between various positions, including a stowed position and an in-flight position. In a stowed position, the movable control interface may be farther away from a pilot seat than the movable control interface is in an in-flight position. Furthermore, in an in-flight position, the movable control interface may be located in front of a pilot seat at an elevation relative to the pilot seat such that the touch screen interface is accessible to the operator while the operator is seated fully in the pilot's seat (e.g., with their back contacting the pilot's seat and without leaning forward to reach the touch screen interface). An example of a movable control interface is described in greater detail with reference to FIGS. 21-27.

In various embodiments, inputs received by the universal vehicle control interfaces 110 can include “steady-hold” inputs, which may be configured to hold a parameter value fixed (e.g., remain in a departed position) without a continuous operator input. Such variants can enable hands-free operation, where discontinuous or discrete inputs can result in a fixed, continuous input. In a specific example, a user of the universal vehicle control interfaces 110 can provide an input (e.g., a speed input) and subsequently remove their hands with the input remaining fixed. Alternatively, or additionally, inputs received by the universal vehicle control interfaces 110 can include one or more self-centering or automatic return inputs, which return to a default state without a continuous user input.

The universal vehicle control router 120 routes universal vehicle control inputs describing operation of a vehicle to components of the vehicle suitable for executing the operation. In particular, the universal vehicle control router 120 receives universal vehicle control inputs describing the operation of the vehicle, processes the inputs using information describing characteristics of the vehicle, and outputs a corresponding set of commands for actuators of the vehicle (e.g., the vehicle actuators 130) suitable to achieve the operation. The universal vehicle control router 120 may use various information describing characteristics of a vehicle in order to convert universal vehicle control inputs to a suitable set of commands for actuators of the vehicle. Additionally, or alternatively, the universal vehicle control router 120 may convert universal vehicle control inputs to a set of actuator commands using a set of control laws that enforce constraints (e.g., limits) on operations requested by the universal control inputs. For example, the set of control laws may include velocity limits (e.g., to prevent stalling in fixed-wing aerial vehicle), acceleration limits, turning rate limits, engine power limits, rotor revolution per minute (RPM) limits, load power limits, allowable descent altitude limits, etc. After determining a set of actuator commands, the universal vehicle control router 120 may transmit the commands to relevant components of the vehicle for causing corresponding actuators to execute the commands. Embodiments of the universal vehicle control router 120 are described in greater detail below with reference to FIG. 2.

The universal vehicle control router 120 can decouple axes of movement for a vehicle in order to process received universal vehicle control inputs. In particular, the universal vehicle control router 120 can process a received universal vehicle control input for one axis of movement without impacting other axes of movement such that the other axes of movement remain constant. In this way, the universal vehicle control router 120 can facilitate “steady-hold” vehicle control inputs, as described above with reference to the universal vehicle control interfaces 110. This is in contrast to conventional systems, where a vehicle operator must manually coordinate all axes of movement independently for a vehicle in order to produce movement in one axis (e.g., a pure turn, a pure altitude climb, a pure forward acceleration, etc.) without affecting the other axes of movement.

In some embodiments, the universal vehicle control router 120 is configured to use one or more models corresponding to a particular vehicle to convert universal vehicle control inputs to a suitable set of commands for actuators of the vehicle. For example, a model may include a set of parameters (e.g., numerical values) that can be used as input to universal input conversion processes in order to generate actuator commands suitable for a particular vehicle. In this way, the universal vehicle control router 120 can be integrated with vehicles by substituting models used by processes of the universal vehicle control router 120, enabling efficient integration of the vehicle control and interface system 100 with different vehicles. The one or more models may be obtained by the universal vehicle control router 120 from a vehicle model database or other first-party or third-party system, e.g., via a network. In some cases, the one or more models may be static after integration with the vehicle control and interface system 100, such as if a vehicle integrated with the vehicle control and interface system 100 receives is certified for operation by a certifying authority (e.g., the United States Federal Aviation Administration (FAA)). In some embodiments, parameters of the one or more models are determined by measuring data during real or simulated operation of a corresponding vehicle and fitting the measured data to the one or more models.

In some embodiments, the universal vehicle control router 120 processes universal vehicle control inputs according to a current phase of operation of the vehicle. For instance, if the vehicle is a rotorcraft, the universal vehicle control router 120 may convert a universal input describing an increase in lateral speed to one or more actuator commands differently if the rotorcraft is in a hover phase or in a forward flight phase. In particular, in processing the lateral speed increase universal input the universal vehicle control router 120 may generate actuator commands causing the rotorcraft to strafe if the rotorcraft is hovering and causing the rotorcraft to turn if the rotorcraft is in forward flight. As another example, in processing a turn speed increase universal input the universal vehicle control router 120 may generate actuator commands causing the rotorcraft to perform a pedal turn if the rotorcraft is hovering and ignore the turn speed increase universal input if the rotorcraft is in another phase of operation. As a similar example for a fixed-wing aerial vehicle, in processing a turn speed increase universal input the universal vehicle control router 120 may generate actuator commands causing the fixed-wing aerial vehicle to perform tight ground turn if the fixed-wing aerial vehicle is grounded and ignore the turn speed increase universal input if the fixed-wing aerial vehicle is in another phase of operation. One skilled in the art will appreciate that the universal vehicle control router 120 may perform other suitable processing of universal vehicle control inputs to generate actuator commands in consideration of vehicle operation phases for various vehicles.

The universal vehicle control router 120 may comprise multiple flight control computers (FCCs) configured to provide instructions to vehicle actuators 130 in a redundant configuration. Each flight control computer may be independent, such that no single failure affects multiple flight control computer simultaneously. Each flight control computer may comprise a processor, multiple control modules, and a fully analyzable and testable (FAT) voter. Each flight control computer may be associated with a backup battery. Each flight control computer may comprise a self-assessment module that inactivates the FCC in the event that the self-assessment module detects a failure. The FAT voters may work together to vote on which FCCs should be enabled.

The vehicle actuators 130 are one or more actuators configured to control components of a vehicle integrated with the universal vehicle control interfaces 110. For instance, the vehicle actuators may include actuators for controlling a power-plant of the vehicle (e.g., an engine). Furthermore, the vehicle actuators 130 may vary depending on the particular vehicle. For example, if the vehicle is a rotorcraft the vehicle actuators 130 may include actuators for controlling lateral cyclic, longitudinal cyclic, collective, and pedal controllers of the rotorcraft. As another example, if the vehicle is a fixed-wing aerial vehicle the vehicle actuators 130 may include actuators for controlling a rudder, elevator, ailerons, and power-plant of the fixed-wing aerial vehicle. Each vehicle actuator 130 may comprise multiple motors configured to move the vehicle actuator 130. Each motor for a vehicle actuator 130 may be controlled by a different FCC. Every vehicle actuator 130 may comprise at least one motor controlled by each FCC. Thus, any single FCC may control every vehicle actuator 130 on the vehicle.

The vehicle sensors 140 are sensors configured to capture corresponding sensor data. In various embodiments the vehicle sensors 140 may include, for example, one or more global positioning system (GPS) receivers, inertial measurement units (IMUs), accelerometers, gyroscopes, magnometers, pressure sensors (altimeters, static tubes, pitot tubes, etc.), temperature sensors, vane sensors, range sensors (e.g., laser altimeters, radar altimeters, lidars, radars, ultrasonic range sensors, etc.), terrain elevation data, geographic data, airport or landing zone data, rotor revolutions per minute (RPM) sensors, manifold pressure sensors, or other suitable sensors. In some cases, the vehicle sensors 140 may include, for example, redundant sensor channels for some or all of the vehicle sensors 140. The vehicle control and interface system 100 may use data captured by the vehicle sensors 140 for various processes. By way of example, the universal vehicle control router 120 may use vehicle sensor data captured by the vehicle sensors 140 to determine an estimated state of the vehicle.

The data store 150 is a database storing various data for the vehicle control and interface system 100. For instance, the data store 150 may store sensor data (e.g., captured by the vehicle sensors 140), vehicle models, vehicle metadata, or any other suitable data.

Example Control Router with Redundant Flight Control Computers

FIG. 2 illustrates one embodiment of a schematic diagram 200 for a universal avionics control router 205 in a redundant configuration, in accordance with one embodiment. The universal avionics control router 205 may be an embodiment of the universal vehicle control router 120. Although the embodiment depicted in FIG. 2 is particularly directed to operating an aerial vehicle (e.g., a rotorcraft or fixed wing aerial vehicle), one skilled in the art will appreciate that similar systems can be used with other vehicles, such as motor vehicles or watercraft.

Aerial vehicle control interfaces 210 are configured to provide universal aerial vehicle control inputs to the universal avionics control router 205. The aerial vehicle control interfaces 210 may be embodiments of the universal vehicle control interfaces 110. In particular, the aerial vehicle control interfaces 210 may include an inceptor device, a gesture interface, and an automated control interface. The aerial vehicle control interfaces 210 may be configured to receive instructions from a human pilot as well as instructions from an autopilot system and convert the instructions into universal aerial vehicle control inputs to the universal avionics control router 205. At a given time, the universal aerial vehicle control inputs may include inputs received from some or all of the aerial vehicle control interfaces 210. Inputs received from the aerial vehicle control interfaces 210 are routed to the universal avionics control router 205. The aerial vehicle control interfaces 210 may generate multiple sets of signals, such as one set of signals for each flight control channel via separate wire harnesses and connectors. Inputs received by the aerial vehicle control interfaces 210 may include information for selecting or configuring automated control processes, such as automated aerial vehicle control macros (e.g., macros for aerial vehicle takeoff, landing, or autopilot) or automated mission control (e.g., navigating an aerial vehicle to a target location in the air or ground).

The universal avionics control router 205 includes a digital interface generator 260 that is configured to generate and update one or more graphical user interfaces (GUIs) of the aerial vehicle control interfaces 210. The digital interface generator 260 may be further configured to display the GUIs generated on a screen (or electronic visual display). The digital interface generator 260 may be a software module executed on a computer of the universal avionics control router 205. The digital interface generator 260 may generate an interface to assist preparation of the vehicle for operation, an interface to enable control the navigation of the vehicle, an interface to end the operation of the vehicle in an orderly manner, any suitable interface for controlling operation of the vehicle, or a combination thereof. The digital interface generator 260 may update the generated GUIs based on measurements taken by the aerial vehicle sensors 245, user inputs received via the aerial vehicle control interfaces 210, or a combination thereof. In particular, the digital interface generator 260 may update the generated GUIs based on determinations by one or more of the flight control computers 220A, 220B, 220C (collectively 220).

The universal avionics control router 205 is configured to convert the inputs received from the aerial vehicle control interfaces 210 into instructions to an actuator 215 configured to move an aerial vehicle component. The universal avionics control router 205 includes flight control computers 220. Each flight control computer 220 includes control modules 225A, 225B, 225C (collectively 225), a FAT voter 230A, 230B, 230C (collectively 230), and one or more processors (not shown). Each flight control computer 220 is associated with a backup power source 235A, 235B, 235C (collectively 235) configured to provide power to the associated flight control computer 220. In the illustrated embodiment, the universal avionics flight control router 205 includes three flight control computers 220. However, in other embodiments, the universal avionics control router 205 may include two, four, five, or any other suitable number of flight control computers 220.

Each flight control computer 220 is configured to receive inputs from the aerial vehicle control interfaces 210 and provide instructions to actuators 215 configured to move aerial vehicle components in a redundant configuration. Each flight control computer 220 operates in an independent channel from the other flight control computer 220. Each independent channel comprises distinct dedicated components, such as wiring, cabling, servo motors, etc., that is separate from the components of the other independent channels. The independent channel includes the plurality of motors 240 to which the flight control computer provides commands. One or more components of each flight control computer 220 may be manufactured by a different manufacturer, be a different model, or some combination thereof, to prevent a design instability from being replicated across flight control computers 220. For example, in the event that a chip in a processor is susceptible to failure in response to a particular sequence of inputs, having different chips in the processors of the other flight control computers 220 may prevent simultaneous failure of all flight control computers in response to encountering that particular sequence of inputs.

Each flight control computer 220 may include two or more (e.g., a plurality of) control modules 225 configured to convert inputs from the aerial vehicle control interfaces 210 and aerial vehicle sensors 245 into actuator instructions. The control modules 225 may comprise an automated aerial vehicle control module, an aerial vehicle state estimation module, a sensor validation module, a command processing module, and a control laws module. The automated aerial vehicle control module may be configured to generate a set of universal aerial vehicle control inputs suitable for executing automated control processes. The automated aerial vehicle control module can be configured to determine that an aerial vehicle is ready for flight. The automated aerial vehicle control module may receive measurements taken by the aerial vehicle sensors 245, determine measurements derived therefrom, of a combination thereof. For example, the automated aerial vehicle control module may receive an N1 measurement from a tachometer of the aerial vehicle sensors 245 indicating a rotational speed of a low pressure engine spool, determine a percent RPM based on an engine manufacturer's predefined rotational speed that corresponds to a maximum rotational speed or 100%, or a combination thereof.

The automated aerial vehicle control module may further be configured to automate the startup of one or more engines of the aerial vehicle. The automated aerial vehicle control module may perform tests during engine startup, which can include multiple stages (e.g., before starting the engine, or “pre-start,” and after starting the engine, or “post-start”). The automated aerial vehicle control module can use measurements taken by sensors of the aerial vehicle (e.g., the vehicle sensors 140) to verify whether one or more of operation criteria or accuracy criteria are met before authorizing the operator to fly the aerial vehicle. The sensor measurements may characterize properties of the engine such as oil temperature, oil pressure, rotational speeds (e.g., N1 or N2), any suitable measurement of an engine's behavior, or combination thereof. For example, the automated aerial vehicle control module may enable the user to increase the engine speed and raise the collective of a helicopter in response to determining that both a first set of operation criteria are met by engine measurements taken before starting the engine, or “pre-start engine parameters,” and a second set of operation criteria are met by engine measurements taken after starting the engine and before takeoff, or “post-start engine parameters.” As referred to herein, an operation criterion may be a condition to be met by a pre-start or post-start engine parameter to determine that one or more actuators of the aerial vehicle are safe to operate. Examples of operation criteria include the engagement of seat belts, a clear area around an aerial vehicle preparing to take off, a target oil pressure or temperature achieved during engine startup, etc. The automated aerial vehicle control module may implement various accuracy and redundancy checks to increase the safety of the automated engine startup. Although the term “automated engine startup” is used herein, the engine startup process may be fully automated or partially automated (e.g., assisted engine startup). The engine startup process and user interfaces displayed during engine startup are described in greater detail with reference to FIGS. 4-7.

The aerial vehicle state estimation module may be configured to determine an estimated aerial vehicle state of the aerial vehicle using validated sensor signals, such as an estimated 3D position of the vehicle with respect to the center of the Earth, estimated 3D velocities of the aerial vehicle with respect to the ground or with respect to a moving air mass, an estimated 3D orientation of the aerial vehicle, estimated 3D angular rates of change of the aerial vehicle, an estimated altitude of the aerial vehicle, or any other suitable information describing a current state of the aerial vehicle.

The sensor validation module is configured to validate sensor signals captured by the aerial vehicle sensors 245. For example, the sensors may be embodiments of the vehicle sensors 140 described above with reference to FIG. 1. Outputs of the sensor validation module may be used by the automated aerial vehicle control module to verify that the aerial vehicle is ready for operation.

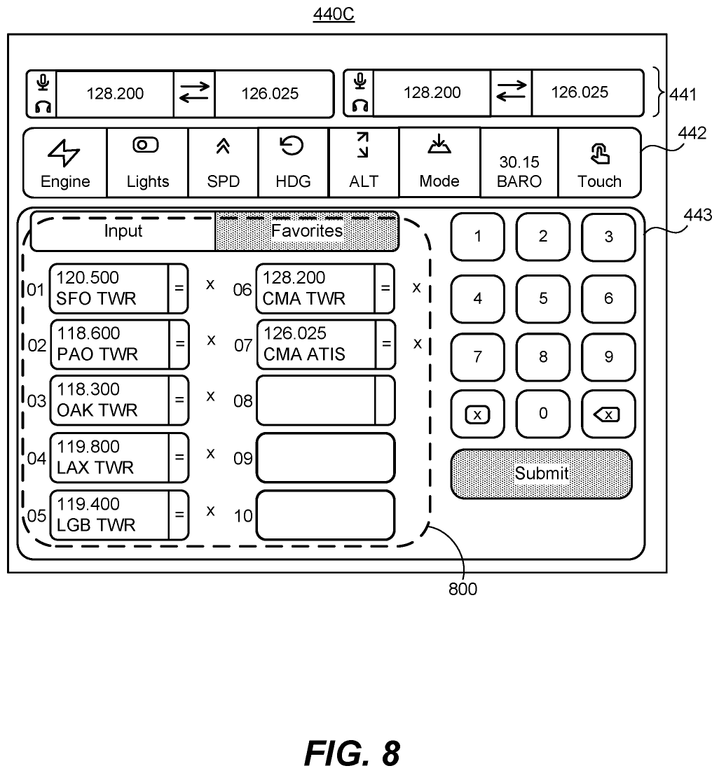

The command processing module is configured to generate aerial vehicle trajectory values using the universal aerial vehicle control inputs. The trajectory values may also be referred to herein as navigation or navigation values. The aerial vehicle trajectory values describe universal rates of change of the aerial vehicle along movement axes of the aerial vehicle in one or more dimensions. The command processing module may be configured to modify non-navigational operation of the aerial vehicle using the universal aerial vehicle control inputs. Non-navigational operation is an operation of the aerial vehicle that does not involve actuators that control the movement of the aerial vehicle. Examples of non-navigational operation includes a temperature inside the cabin, lights within the cabin, a position of an electronic display within the cabin, audio output (e.g., speakers) of the aerial vehicle, one or more radios of the aerial vehicle (e.g., very-high-frequency radios for identifying and communication with ground stations for navigational guidance information), any suitable operation of the aerial vehicle that operates independently of the aerial vehicle's movement, or a combination thereof. The universal aerial vehicle control inputs may be received through GUIs generated by the digital interface generator 260. Examples of control inputs, including finger gestures to change an aerial vehicle's navigation, are described in greater detail with reference to FIGS. 8-20.

The control laws module is configured to generate the actuator commands (or signals) using the aerial vehicle position values. The control laws module includes an outer processing loop and an inner processing loop. The outer processing loop applies a set of control laws to the received aerial vehicle position values to convert aerial vehicle position values to corresponding allowable aerial vehicle position values. Conversely, the inner processing loop converts the allowable aerial vehicle position values to the actuator commands configured to operate the aerial vehicle to achieve the allowable aerial vehicle position values. Both the outer processing loop and the inner processing loop are configured to operate independently of the particular aerial vehicle including the universal avionics control router 205. In order to operate independently in this manner, the inner and outer processing loops may use a model including parameters describing characteristics of the aerial vehicle that can be used as input to processes or steps of the outer and inner processing loops. The control laws module may use the actuator commands to directly control corresponding actuators, or may provide the actuator commands to one or more other components of the aerial vehicle to be used to operate the corresponding actuators.

The FAT voters 230 are configured to work together to determine which channels should be prevented from controlling the downstream functions, such as control of an actuator 215. Each FAT voter 230 comprises a channel enable logic configured to determine whether that channel should remain active. In response to a FAT voter 230 determining that its associated flight control computer 220 is malfunctioning during a self-assessment routine, the FAT voter 230 may disconnect the flight control computer 220 from the motors 240 in its channel, thus disconnecting the flight control computer 220 from all actuators 215. The self-assessment is performed in the processor of the flight control computer 220 based on high assurance software. The self-assessment routine assumes that the processor is in good working order. Each flight control computer 220 evaluates the signal output by the other channels to determine whether the other channels should be deactivated. Each flight control computer 220 compares the other flight control computers' 220 control commands to the downstream functions as well as other signals contained in the cross-channel data link to its own. Each flight control computer 220 may be connected to the other flight control computers 220 via a cross-channel data link. The flight control computer 220 executes a failure detection algorithm to determine the sanity of the other flight control computers 220. In response to other flight control computers 220 determining that a flight control computer 220 is malfunctioning, the FAT voter 230 for the malfunctioning flight control computer 220 may disconnect the malfunctioning flight control computer 220 from the motors 240 in its channel. In some embodiments, the FAT voter 230 may disconnect power to the malfunctioning flight control computer 220.

The backup power sources 235 are configured to provide power to the flight control computers 220 and motors 240 in the event of a disruption of power from a primary power source 250. The backup power source 235 may comprise a battery, an auxiliary generator, a flywheel, an ultra-cap, some other power source, or some combination thereof. The backup power source 235 may be rechargeable, but can alternately be a single use, and/or have any suitable cell chemistry (e.g., Li-ion, Ni-cadmium, lead-acid, alkaline, etc.). The backup power source is sufficiently sized to concurrently power all flight components necessary to provide aerial vehicle control authority and or sustain flight (e.g., alone or in conjunction with other backup power sources). The backup power source 235 may be sized to have sufficient energy capacity to enable a controlled landing, power the aerial vehicle for a at least a predetermined time period (e.g., 10 minutes, 20 minutes, 30 minutes, etc.), or some combination thereof. In some embodiments, the backup power source 235 can power the flight control computer 220, aerial vehicle sensors 245, and the motors 240 for the predetermined time period.

The backup power sources (or systems) 235 can include any suitable connections. In some embodiments, each backup power source 235 may supply power to a single channel. In some embodiments, power can be supplied by a backup power source 235 over multiple channels, shared power connection with other backup power systems, and/or otherwise suitably connected. In some embodiments, the backup power sources 235 can be connected in series between the primary power source 250 and the flight control computer 220. In some embodiments, the backup power source 235 can be connected to the primary power source 250 during normal operation and selectively connected to the flight control computer 220 during satisfaction of a power failure condition. In some embodiments, the backup power source 235 can be connected in parallel with the primary power source 250. However, the backup power source can be otherwise suitably connected.

The backup power sources 235 may be maintained at substantially full state of charge (SoC) during normal flight (e.g., 100% SoC, SoC above a predetermined threshold charge), however can be otherwise suitably operated. In some embodiments, the backup power sources 235 draw power from the primary power source 250 during normal flight, may be pre-charged (or installed with a full charge) before flight initiation, or some combination thereof. The backup power sources 235 may employ load balancing to maintain a uniform charge distribution between backup power sources 235, which may maximize a duration of sustained, redundant power. Load balancing may occur during normal operation (e.g., before satisfaction of a power failure condition), such as while the batteries are drawing power from the primary power source 250, during discharge, or some combination thereof.

Backup power may be employed in response to satisfaction of a power failure condition. A power failure condition may include: failure to power the actuator from aerial vehicle power (e.g., main power source, secondary backup systems such as ram air turbines, etc.), electrical failure (e.g., electrical disconnection from primary power bus, power cable failure, blowing a fuse, etc.), primary power source 250 (e.g., generator, alternator, engine, etc.) failure, power connection failure to one or more flight components (e.g., actuators, processors, drivers, sensors, batteries, etc.), fuel depletion below a threshold (e.g., fuel level is substantially zero), some other suitable power failure condition, or some combination thereof. In some embodiments, a power failure condition can be satisfied by a manual input (e.g., indicating desired use of backup power, indicating a power failure or other electrical issue).

The motors 240A, 240B, 240C (collectively 240) are configured to move an actuator 215 to modify the position of an aerial vehicle component. Motors 240 may include rotary actuators (e.g., motor, servo, etc.), linear actuators (e.g., solenoids, solenoid valves, etc.), hydraulic actuators, pneumatic actuators, any other suitable motors, or some combination thereof. In some embodiments, an actuator 215 may comprise one motor 240 and associated electronics in each channel corresponding to each flight control computer 220. For example, the illustrated actuator 215 comprises three motors 240, each motor 240 associated with a respective flight control computer 220. In some embodiments, an actuator 215 may comprise a single motor 240 that comprises an input signal from each channel corresponding to each flight control computer 220. Each flight control computer 220 may be capable of controlling all actuators 215 by controlling all motors 240 within that channel.

The actuators 215 may be configured to manipulate control surfaces to affect aerodynamic forces on the aerial vehicle to execute flight control. The actuators 215 may be configured to replace manual control to components, include the power-plant, flaps, brakes, etc. In some embodiments, actuators 215 may comprise electromagnetic actuators (EMAs), hydraulic actuators, pneumatic actuators, any other suitable actuators, or some combination thereof. Actuators 215 may directly or indirectly manipulate control surfaces. Control surfaces may include rotary control surfaces (e.g., rotor blades), linear control surfaces, wing flaps, elevators, rudders, ailerons, any other suitable control surfaces, or some combination thereof. In some embodiments, actuators 215 can manipulate a swashplate (or linkages therein), blade pitch angle, rotor cyclic, elevator position, rudder position, aileron position, tail rotor RPM, any other suitable parameters, or some combination thereof. In some embodiments, actuators 215 may include devices configured to power primary rotor actuation about the rotor axis (e.g., in a helicopter).

The motors 240 may be electrically connected to any suitable number of backup power sources via the harness. The motors 240 can be connected to a single backup power source, subset of backup power sources, and/or each backup power source. In normal operation, each motor 240 in each channel may be powered by the flight control computer 220 in that channel. The motors 240 may be wired in any suitable combination/permutation of series/parallel to each unique power source in each channel. The motors 240 may be indirectly electrically connected to the primary power source 250 via the backup power source (e.g., with the backup power source connected in series between the motor 240 and primary power source 250), but can alternatively be directly electrically connected to the primary power source 250 (e.g., separate from, or the same as, that powering the backup power source). The flight control computer 220 in each channel independently powers and provides signals to each channel.

The various components may be connected by a harness, which functions to electrically connect various endpoints (e.g., modules, actuators, primary power sources, human machine interface, external sensors, etc.) on the aerial vehicle. The harness may include any suitable number of connections between any suitable endpoints. The harness may include a single (electrical) connector between the harness and each module, a plurality of connectors between each harness and each module, or some combination thereof. In some embodiments, the harness includes a primary power (e.g., power in) and a flight actuator connection (e.g., power out) to each module. In some embodiments, the harness can include separate power and data connections, but these can alternately be shared (e.g., common cable/connector) between various endpoints. The harness may comprise inter-module connections between each module and a remainder of the modules.

The harness may comprise intra-module electrical infrastructure (e.g., within the housing), inter-module connections, connections between modules and sensors (e.g., magnetometers, external air data sensors, GPS antenna, etc.), connections between modules and the human machine interface, and/or any other suitable connections. Intra-module connections can, in variants, have fewer protections (e.g., electro-magnetic interference (EMI) protections, environmental, etc.) because they are contained within the housing. In variants, inter-module connections can enable voting between processors, sensor fusion, load balancing between backup power sources, and/or any other suitable power/data transfer between modules. In variants retrofitting an existing aerial vehicle and/or installed after-market, the harness can integrate with and/or operate in conjunction with (e.g., use a portion of) the existing aerial vehicle harness.

### Example Vehicle Control Interfaces

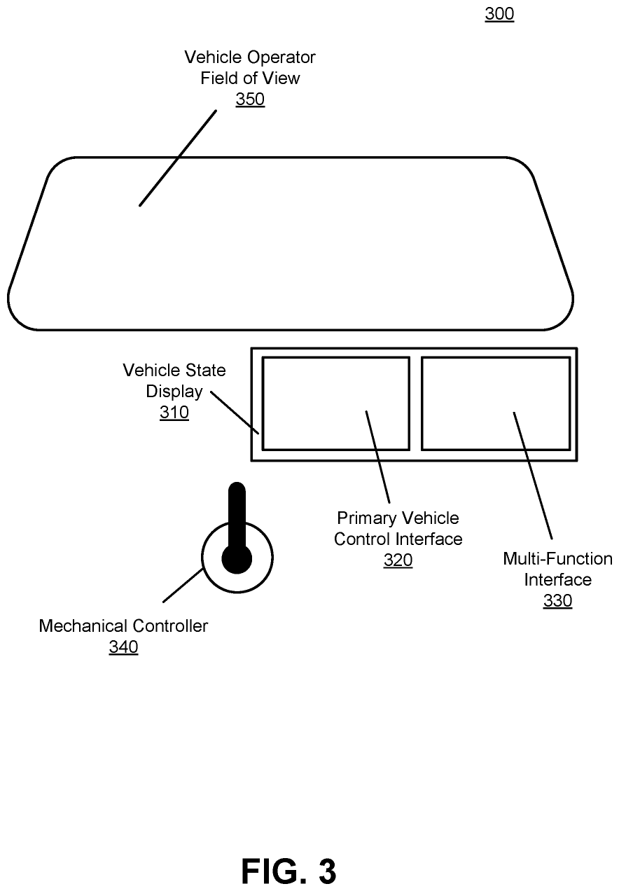

FIG. 3 illustrates a configuration 300 for a set of universal vehicle control interfaces in a vehicle, in accordance with one embodiment. The vehicle control interfaces in the configuration 300 may be embodiments of the universal vehicle control interfaces 110, as described above with reference to FIG. 1. In the embodiment shown, the configuration 300 includes a vehicle state display 310, a mechanical controller 340, and a vehicle operator field of view 350. In other embodiments, the configuration 300 may include different or additional elements. Furthermore, the functionality may be distributed among the elements in a different manner than described.

The vehicle state display 310 is one or more electronic displays (or screens), which may be, for example, liquid-crystal displays (LCDs), organic light emitting displays (OLED), or plasma. The vehicle stat display 310 may be configured to display (or provide for display) received information describing a state of the vehicle including the configuration 300. In particular, the vehicle state display 310 may display various interfaces including feedback information for an operator of the vehicle. In this case, the vehicle state display 310 may provide feedback information to the operator in the form of virtual maps, 3D terrain visualizations (e.g., wireframe, rendering, environment skin, etc.), traffic, weather, engine status, communication data (e.g., air traffic control (ATC) communication), guidance information (e.g., guidance parameters, trajectory), and any other pertinent information. Additionally, or alternatively, the vehicle state display 310 may display various interfaces for configuring or executing automated vehicle control processes, such as automated aerial vehicle landing or takeoff or navigation to a target location. The vehicle state display 310 may receive user inputs via various mechanisms, such as gesture inputs (as described above with reference to the gesture interface 320), audio inputs, or any other suitable input mechanism.

As depicted in FIG. 3 the vehicle state display 310 includes a primary vehicle control interface 320 and a multi-function interface 330. The primary vehicle control interface 320 is configured to facilitate short-term of the vehicle including the configuration 300. In particular, the primary vehicle control interface 320 includes information immediately relevant to control of the vehicle, such as current universal control input values or a current state of the vehicle. As an example, the primary vehicle control interface 320 may include a virtual object representing the vehicle in 3D or 2D space. In this case, the primary vehicle control interface 320 may adjust the display of the virtual object responsive to operations performed by the vehicle in order to provide an operator of the vehicle with visual feedback. The primary vehicle control interface 320 may additionally, or alternatively, receive universal vehicle control inputs via gesture inputs.

The multi-function interface 330 is configured to facilitate long-term control of the vehicle including the configuration 300. In particular, the primary vehicle control interface 320 may include information describing a mission for the vehicle (e.g., navigation to a target destination) or information describing the vehicle systems. Information describing the mission may include routing information, mapping information, or other suitable information. Information describing the vehicle systems may include engine health status, engine power utilization, fuel, lights, vehicle environment, or other suitable information. In some embodiments, the multi-function interface 330 or other interfaces enable mission planning for operation of a vehicle. For example, the multi-function interface 330 may enable configuring missions for navigating a vehicle from a start location to a target location. In some cases, the multi-function interface 330 or another interface provides access to a marketplace of applications and services. The multi-function interface 330 may also include a map, a radio tuner, or a variety of other controls and system functions for the vehicle.

In some embodiments, the vehicle state display 310 includes information describing a current state of the vehicle relative to one or more control limits of the vehicle (e.g., on the primary vehicle control interface 320 or the multi-function interface 330). For example, the information may describe power limits of the vehicle or include information indicating how much control authority a use has across each axis of movement for the vehicle (e.g., available speed, turning ability, climb or descent ability for an aerial vehicle, etc.). In the same or different example embodiment, the vehicle state display 310 may display different information depending on a level of experience of a human operator of the vehicle. For instance, if the vehicle is an aerial vehicle and the human operator is new to flying, the vehicle state display may include information indicating a difficulty rating for available flight paths (e.g., beginner, intermediate, or expert). The particular experience level determined for an operator may be based upon prior data collected and analyzed about the human operator corresponding to their prior experiences in flying with flight paths having similar expected parameters. Additionally, or alternatively, flight path difficulty ratings for available flight paths provided to the human operator may be determined based on various information, for example, expected traffic, terrain fluctuations, airspace traffic and traffic type, how many airspaces and air traffic controllers along the way, or various other factors or variables that are projected for a particular flight path. Moreover, the data collected from execution of this flight path can be fed back into the database and applied to a machine learning model to generate additional and/or refined ratings data for the operator for subsequent application to other flight paths. Vehicle operations may further be filtered according to which one is the fastest, the most fuel efficient, or the most scenic, etc.

The one or more vehicle state displays 310 may include one or more electronic displays (e.g., liquid-crystal displays (LCDs), organic light emitting diodes (OLED), plasma). For example, the vehicle state display 310 may include a first electronic display for the primary vehicle control interface 320 and a second electronic display for the multi-function interface 330. In cases where the vehicle state display 310 include multiple electronic displays, the vehicle state display 310 may be configured to adjust interfaces displayed using the multiple electronic displays, e.g., in response to failure of one of the electronic displays. For example, if an electronic display rendering the primary vehicle control interface 320 fails, the vehicle state display 310 may display some or all of the primary vehicle control interface 320 on another electronic display.

The one or more electronic displays of the vehicle state display 310 may be touch sensitive displays is configured to receive touch inputs from an operator of the vehicle including the configuration 300, such as a multi-touch display. For instance, the primary vehicle control interface 320 may be a gesture interface configured to receive universal vehicle control inputs for controlling the vehicle including the configuration 300 via touch gesture inputs. In some cases, the one or more electronic displays may receive inputs via other type of gestures, such as gestures received via an optical mouse, roller wheel, three-dimensional (3D) mouse, motion tracking device (e.g., optical tracking), or any other suitable device for receiving gesture inputs. Touch gesture inputs received by one or more electronic displays of the vehicle state display 310 may include single finger gestures (e.g., executing a predetermined pattern, swipe, slide, etc.), multi-finger gestures (e.g., 2, 3, 4, 5 fingers, but also palm, multi-hand, including/excluding thumb, etc.; same or different motion as single finger gestures), pattern gestures (e.g., circle, twist, convergence, divergence, multi-finger bifurcating swipe, etc.), or any other suitable gesture inputs. Gesture inputs can be limited asynchronous inputs (e.g., single input at a time) or can allow for multiple concurrent or synchronous inputs. In variants, gesture input axes can be fully decoupled or independent. In a specific example, requesting a speed change holds other universal vehicle control input parameters fixed—where vehicle control can be automatically adjusted in order to implement the speed change while holding heading and vertical rate fixed. Alternatively, gesture axes can include one or more mutual dependencies with other control axes. Unlike conventional vehicle control systems, such as aerial vehicle control systems, the gesture input configuration as disclosed provides for more intuitive user experiences with respect to an interface to control vehicle movement.

In some embodiments, interfaces at the vehicle state display 310 or other interfaces are configured to adjust in response to vehicle operation events, such as emergency conditions. For instance, in response to determining the vehicle is in an emergency condition, the vehicle control and interface system 100 may adjust the primary vehicle control interface 320 to include essential information or remove irrelevant information. As an example, if the vehicle is an aerial vehicle and the vehicle control and interface system 100 detects an engine failure for the aerial vehicle, the vehicle control and interface system 100 may display essential information on the vehicle state display 310 including 1) a direction of the wind, 2) an available glide range for the aerial vehicle (e.g., a distance that the aerial vehicle can glide given current conditions), or 3) available emergency landing spots within the glide range. The vehicle control and interface system 100 may identify emergency landing locations using various processes, such as by accessing a database of landing spots (e.g., included in the data store 150 or a remote database) or ranking landing spots according to their suitability for an emergency landing.

The mechanical controller 340 may be configured to receive universal vehicle control inputs. In particular, the mechanical controller 340 may be configured to receive the same or similar universal vehicle control inputs as a gesture interface of the vehicle state display 310 is configured to receive. In this case, the gesture interface and the mechanical controller 340 may provide redundant or semi-redundant interfaces to a human operator for providing universal vehicle control inputs. The mechanical controller 340 may be active or passive. Additionally, the mechanical controller 340 and may include force feedback mechanisms along any suitable axis. For instance, the mechanical controller 340 may be a 4-axis controller (e.g., with a thumbwheel).

The components of the configuration 300 may be integrated with the vehicle including the configuration 300 using various mechanical or electrical components. These components may enable adjustment of one or more interfaces of the configuration 300 for operation by a human operator of the vehicle. For example, these components may enable rotation or translation of the vehicle state display 330 toward or away from a position of the human operator (e.g., a seat where the human operator sits). Such adjustment may be intended, for example, to prevent the interfaces of the configuration 300 from obscuring a line of sight of the human operator to the vehicle operator field of view 350.

The vehicle operator field of view 350 is a first-person field of view of the human operator of the vehicle including the configuration 300. For example, the vehicle operator field of view 350 may be a windshield of the vehicle or other suitable device for enabling a first-person view for a human operator.

The configuration 300 additionally or alternately include other auxiliary feedback mechanisms, which can be auditory (e.g., alarms, buzzers, etc.), haptic (e.g., shakers, haptic alert mechanisms, etc.), visual (e.g., lights, display cues, etc.), or any other suitable feedback components. Furthermore, displays of the configuration 300 (e.g., the vehicle state display 310) may simultaneously or asynchronously function as one or more of different types of interfaces, such as an interface for receiving vehicle control inputs, an interface for displaying navigation information, an interface for providing alerts or notifications to an operator of the vehicle, or any other suitable vehicle instrumentation. Furthermore, portions of the information may be shared between multiple displays or configurable between multiple displays.

A benefit of the configuration 300 is to minimize the intricacies of vehicle operation that an operator would handle in a conventional vehicle control system. The mechanical controller described herein contributes to this benefit by providing vehicle movement controls through fewer user inputs than a conventional vehicle control system. For example, an aerial vehicle may have a hand-operated control stick for controlling the elevator and aileron, foot-operated pedals for controlling the rudder, buttons for controlling throttle, propeller, and other controls throughout the cockpit of the aerial vehicle. In one embodiment, the mechanical controller described herein may be operated using a single hand of the operator to control the speed and direction of the aerial vehicle. For example, the operator may move the mechanical controller about the lateral, longitudinal, and directional axes corresponding to instructions for operating the elevator, aileron, and rudder of the aerial vehicle to control direction. Further, the operator may use the thumb of their hand already holding the mechanical controller to control a fourth-axis input of the mechanical controller and control speed of the aerial vehicle. For example, the operator spins a thumbwheel on the mechanical controller to increase or decrease the speed of the aerial vehicle. In at least this way, the configuration 300 and the mechanical controller described herein may reduce the cognitive load demanded of a vehicle operator.

### Example Engine Startup Using the Vehicle Control and Interface System

Referring now to FIGS. 4-7, various example interfaces and methods for preparing an engine of an aerial vehicle for flight are described. A vehicle control and interface system may fully or partially automate a process for verifying that an aerial vehicle is safe to operate before authorizing an operator to fly in the aerial vehicle. This process may include an engine startup, which refers to a process for verifying that the engine of an aerial vehicle is ready for safe operation. In some embodiments, a vehicle control and interface system generates a GUI that has one button (e.g., a sliding button) to instruct a flight control computer to begin the process for performing safety checks before and after starting an engine of an aerial vehicle to determine that the aerial vehicle is safe to operate. Unlike existing engine startup procedures (e.g., for automobiles), the engine startup performed by the vehicle control and interface system described herein implements various and/or multiple quality assurance mechanisms (e.g., accuracy checks and/or redundancy mechanisms) to increase the likelihood that the automated checks performed by the vehicle control and interface system are reliable. Engine startup for aerial vehicles has conventionally been performed fully manually by human operators due to the safety risks that may be brought upon by a computer error. By implementing the accuracy checks and/or redundancy mechanisms described herein, the vehicle control and interface system achieves safety with automation that existing systems lack.

FIG. 4 shows a GUI 400 generated by a vehicle control and interface system at an electronic display of the aerial vehicle before starting an engine of the aerial vehicle, in accordance with one or more embodiments. The vehicle control and interface system may be the vehicle control and interface system 100. The GUI 400 shown in FIGS. 4-6 are non-limiting examples of interfaces rendered on the electronic display for depicting information and user control inputs related to preparing the aerial vehicle for flight. In different embodiments, different configurations of user interface elements (e.g., using dials instead of tapes to depict aerial vehicle vertical speed) or different GUIs (e.g., to present different information) may be generated by the vehicle control and interface system 100.

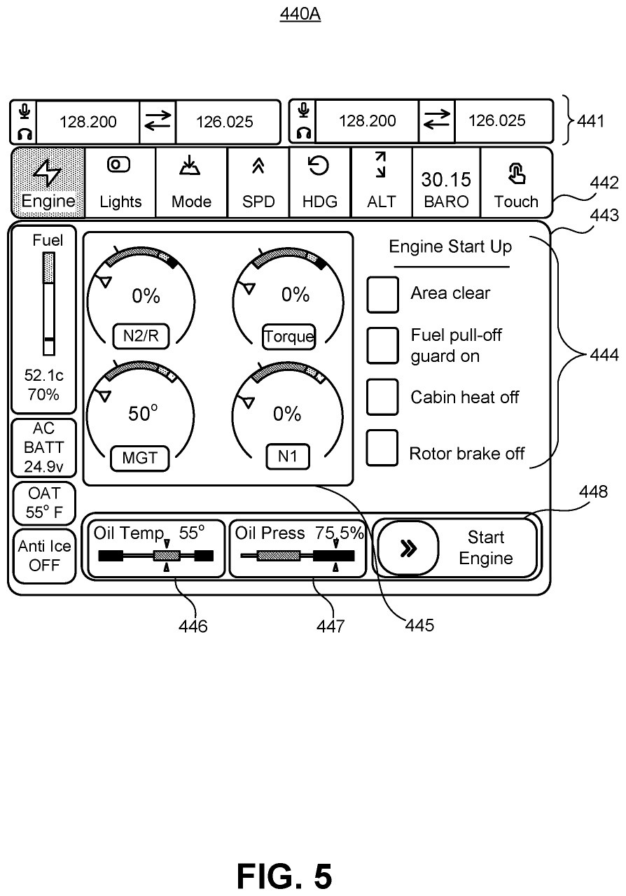

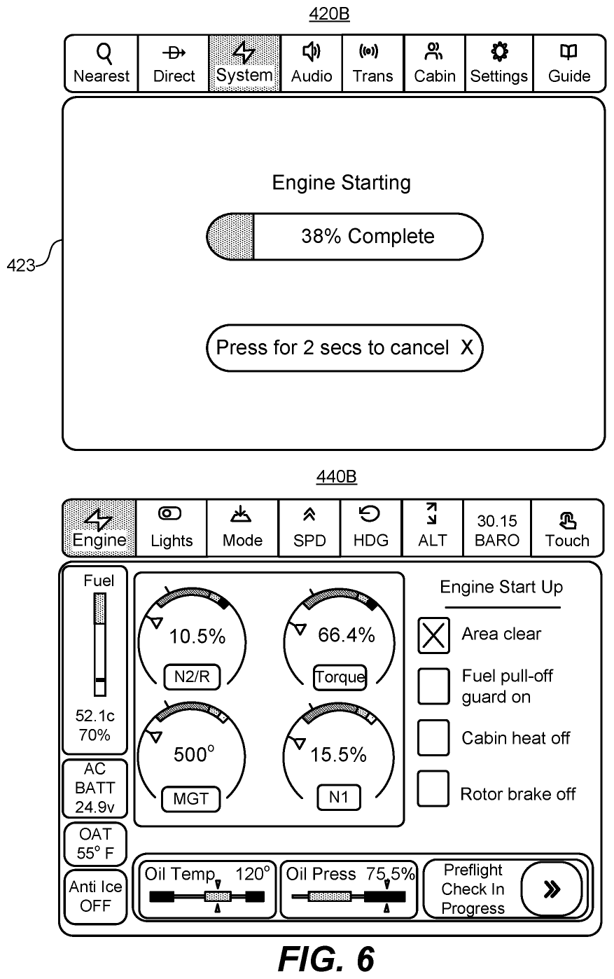

The GUI 400 is divided into at least two sections. To promote clarity, the GUI 400 is depicted with an abstract portrayal of certain details (e.g., the road map is depicted with fewer roads). FIG. 5 depicts the navigation configuration interface 440A in greater detail. FIG. 6 includes a depiction of an embodiment of the aerial vehicle and trip configuration interface 420A in greater detail. The reference numerals 410, 420, 430, and 440 are used throughout FIGS. 4-6 and FIGS. 8-19 with additional alphabetic reference letters to refer to various embodiments of the subsections of the GUI 400. The GUI 400 may be interactive, updating in response to receiving a user input via a mechanism such as a touch screen interface, a mechanical controller stick, a keyboard, any suitable user input control for an aerial vehicle, or a combination thereof. The universal vehicle control router 120 may include some or all of the components of the universal avionics control router 205, including the digital interface generator 260, which may generate the GUI 400 and the various embodiments of subsections 410, 420, 430, and 440.

A first section of the GUI 400 includes the trip visualization interface 410A and the navigation visualization interface 430A. The first section of the GUI 400 displays information related to the trip such as information about an environment around the aerial vehicle, the route, the aerial vehicle, or the cabin. Environment information can include a map of the environment (e.g., roadmap, topographic map, etc.) or a state of the environment (weather, temperature, wind speeds, etc.). Examples of route information can include a series of navigational radio (NAV) frequencies that aerial vehicle will switch between as the aerial vehicle approaches the corresponding control towers enroute to its destination, any suitable characterization of a route taken by an aerial vehicle, or a combination thereof. Examples of aerial vehicle information include measurements describing the types of actuators with which the aerial vehicle is equipped and status thereof, a fuel tank of the aerial vehicle and status thereof (e.g., an amount of fuel stored within a tank), the types of sensors with which the aerial vehicle is equipped and status thereof, measurements describing the size of the aerial vehicle or components thereof, any suitable characterization of the aerial vehicle's behavior or manufacture, or a combination thereof. Examples of cabin information include a number of passengers in the cabin, the occupation status of seats within the cabin, a seat belt lock status of a seat, a weight of luggage aboard the aerial vehicle, any suitable characterization of the cabin of the aerial vehicle, or a combination thereof.

The trip visualization interface 410A includes a map 411 of the environment through which the aerial vehicle is preparing to travel (or if the engine is already started and the vehicle is underway—currently traveling). Any suitable map may be displayed in the trip visualization interface 410A (e.g., political map, physical map, topographic map, road map, etc.). The map 411 may include landmarks to guide an operator and information describing the landmark. For example, the digital interface generator 260 may generate a visual indicator of a physical landmark, e.g., Dodger Stadium in Los Angeles, California, in a road map, e.g., of Los Angeles in this example, to indicate to the operator that a particular navigational operation is to be made as the user approaches the landmark, e.g., Dodger Stadium. The digital interface generator 260 may customize the visual indicator according to the landmark to aid the operator in understanding the context of the landmark (e.g., generating an icon of a generic stadium or of Dodger Stadium for an operator who is unfamiliar with baseball and does not know what Dodger Stadium is). As displayed in FIG. 4, the map 411 reflects the position of the aerial vehicle at Zamperini Field having an International Civil Aviation Organization (ICAO) code of KTOA. The avatar 412 of the aerial vehicle is shown at KTOA along with a planned flight path designated by a line 413 overlayed on the map 411.

The aerial vehicle and trip configuration interface 420A includes various interactive interfaces for displaying or modifying route information. The interactive interfaces include a NAV frequency dashboard 421, a route control and settings menu 422, and a display window 423 that can change to display various content in response to an operator selecting a button of the route control and settings menu 422. The NAV frequency dashboard 421 includes one or more radio frequencies for receiving navigational information (e.g., transmissions from a marker beacon in instrument landing system (ILS) navigation). The frequencies may be displayed as selectable user input controls. The digital interface generator 260 may display additional user controls for changing a NAV frequency in response to an operator selecting a displayed frequency. The route control and settings menu 422 can include user input controls (e.g., buttons) for selecting different content related to the trip or the aerial vehicle (e.g., searching for a destination or displaying information about the aerial vehicle's cabin). As displayed in FIG. 4, the display window 423 of the aerial vehicle and trip configuration interface 420 is blank, corresponding to an absence of a user selection of a button of the route control and settings menu 422. Examples of different content that may be displayed within the display window 423 is described herein (e.g., FIGS. 6 and 15-19).

A second section of the GUI 400 includes the navigation visualization interface 430A and the navigation configuration interface 440A. The second section of the GUI 400 displays information related to the navigation of the aerial vehicle, or “navigation information.” Navigation information describes data that affects the movement of the aerial vehicle (e.g., operations performed during takeoff, flight, and landing). Examples of navigation information include information describing actuator operation (e.g., engine parameters such as rotational speeds) before, during, and after flight. Navigation information can include measurements taken by sensors of the aerial vehicle describing the aerial vehicle's movement (e.g., altitude, attitude, speed, etc.). Navigation information may include communication radio (COM) frequencies used to allow the operators or passengers of the aerial vehicle to communicate with ground stations, other aerial vehicles, any suitable radio transceiver, or combination thereof. The navigation information may be displayed via various aerial vehicle monitor graphics that provide an operator with status information related to aerial vehicle operation.

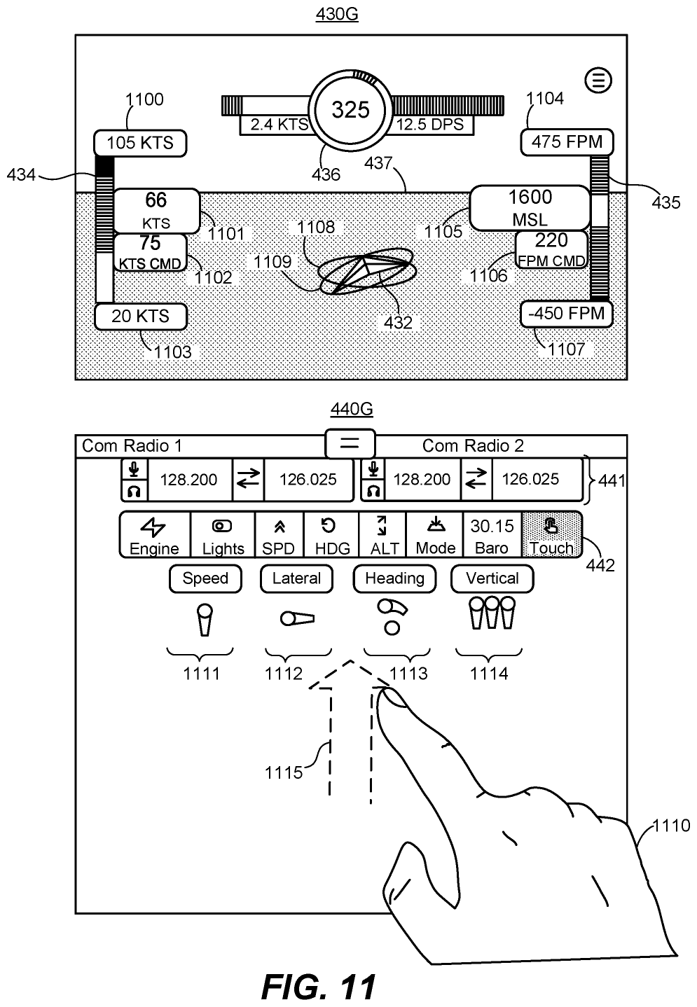

The navigation visualization interface 430A includes a flight display with instrument indicators. The flight display includes an avatar 432 of the aerial vehicle, one or more attitude indicators 431, and a horizon line 437. The avatar 432 may be a three-dimensional (3D) avatar that represents the aerial vehicle. The avatar 432 may be displayed at a third-person perspective (e.g., the operator is viewing the avatar 432 as if located outside of the aerial vehicle). The attitude indicators 431 may include a first indicator that tracks a current angle of the lateral or longitudinal axis of the aerial vehicle and a second indicator that tracks a level angle of the longitudinal axis when the aerial vehicle is maintaining level flight. The attitude indicators 431 may be concentric circles centered at the avatar 432. The horizon line 437 may be a fixed horizon line. That is, the horizon line 437 maintains a position throughout operation of the aerial vehicle (i.e., the same pixels on the electronic display are consistently used to display the horizon line 437). The instrument indicators can include a heading indicator 436, an airspeed indicator 434, and a vertical speed indicator 435. The airspeed indicator 434 and the vertical speed indicator 435 may include tapes that indicate a potential for the operator to reach a maximum airspeed or vertical speed, respectively. As depicted in FIG. 4, which shows an embodiment of the GUI 400 before the operator has been authorized to fly, the tapes are depicted using a solid black shade to indicate that no potential airspeed or vertical speed may be obtained while the operator has not yet been authorized to fly the aerial vehicle. An additional example of a manner in which the tapes can be depicted are shown in FIG. 11.

The navigation configuration interface 440A displays information and input controls to control the actuators and the navigation of the aerial vehicle. The navigation configuration interface 440A is described in greater detail with respect to FIG. 5. The embodiment of navigation configuration interface 440A depicted in FIGS. 4 and 5 reflect the display of information and input controls before an operator has been authorized to operate the aerial vehicle (e.g., before startup safety checks have been completed by the vehicle control and interface system 100).

FIG. 5 is a depiction of the navigation configuration interface 440A of the GUI 400 of FIG. 4 in greater detail, in accordance with one or more embodiments. The navigation configuration interface 440A includes a communication (COM) frequency dashboard 441, a navigational control menu 442, and a navigational control window 443 that updates according to the button of the navigational control menu 442 presently selected by the operator or automatically selected by the vehicle control and interface system 100. The COM frequency dashboard 441 shows frequencies at which one or more communication radios of the aerial vehicle are tuned to receive or transmit audio. The COM frequency dashboard 441 may be interactive. For example, in response to receiving a user input (e.g., a tap) at a frequency displayed at the dashboard 441, the digital interface generator 260 may update the navigation configuration interface 440A to display a number pad, dropdown menu, or any suitable input control to enable the operator to select a different frequency.

The navigational control menu 442 includes various user-selectable icons to control what is displayed at the window 443. As depicted in FIG. 5, the Engine icon is selected to show the status of parameters describing the engine in the window 443. Additional icons can include a Lights icon for controlling lights internal or external to the aerial vehicle, an SPD icon (speed) for controlling the speed of the aerial vehicle, an HDG icon (heading) for controlling the heading of the aerial vehicle, an ALT icon (altitude) for controlling the altitude of the aerial vehicle, a BARO icon (barometer) for viewing air pressure in the environment within or outside the aerial vehicle, and a Touch icon for defining and inputting finger gestures to control operation of the aerial vehicle via a virtual touchpad.

The navigational control window 443 displays information and user input controls based on a selection of a button within the navigational control menu 442. The navigational control window 443, as depicted in FIG. 5, displays measurements of an engine of the aerial vehicle and input controls for controlling operation of the engine. The measurements of the engine may be displayed using aerial vehicle monitor graphics, which refer to graphics that display information of the navigation (e.g., heading) or actuator status (e.g., engine torque) of an aerial vehicle to an operator of the aerial vehicle. The aerial vehicle monitor graphics can be generated by the digital interface generator 260. Examples of aerial vehicle monitor graphics include gauges, tapes, compasses, any suitable format for displaying information related to the navigation or actuators of an aerial vehicle, or combination thereof. The displayed measurements include turbine rotational measurements such as N2/R and N1, engine torque, and measured gas temperature (MGT) via the engine parameter gauges 445. Each of the gauges 445 may include a range of safe and unsafe operating values for engine parameters after the engine has started, or post-start engine parameters. The displayed measurements further include engine oil measurements such as temperature and pressure displayed via the linear gauges 446 and 447, respectively. The window 443 may display other measurements related to the operation of the aerial vehicle such as an amount of fuel, an operating voltage of a battery associated with the engine, an outside air temperature (OAT), or an activation status of an anti-icing system of the aerial vehicle. The navigational control window 443 displays an interactive checklist 444 of manually verified engine start controls. Items in the checklists may include a check that an area around the aerial vehicle is clear, that the fuel pull-off guard is on, the cabin heat is off, and the rotor brake is off. In response to an operator verifying one of the items on the checklist, the operator may select a corresponding checkbox and the digital interface generator 260 may update the checklist 444 to generate a check or other suitable marker within the box to indicate completion. The manually verified engine start controls depicted in FIG. 5 are non-limiting examples, and any suitable combination of verification that is designated to be performed by a human operator onboard the aerial vehicle may be additionally or alternatively displayed at the navigation configuration interface 440A.

To instruct one or more actuators of the aerial vehicle to start an engine, an operator may select the Start Engine sliding button 448 (e.g., use a finger to swipe across the touch screen interface over the sliding button 448). In some embodiments, the digital interface generator 260 may disable the sliding button 448 from being an interactive button until a set of pre-start engine checks are performed. That is, the operator may not start the engine until the checks are performed. The universal control router 120 may determine a set of pre-start engine parameters such as a seat belt lock state, a fuel valve state, a brake engagement state, a circuit breaker state, a freedom of movement state (e.g., determining that controller stick has a full range of motion or that ailerons of the aerial vehicle have their full range of motion), any suitable state of software or hardware of the aerial vehicle that may be determined prior to the start of an engine of the aerial vehicle, or a combination thereof. In response to one or more control modules of the universal vehicle control router 120 determining that the pre-start engine parameters satisfy a set of operation criteria, the digital interface generator 260 may update the navigation configuration interface 440A to enable the sliding button 448 to be interactive. For example, a control module may determine that the circuit breakers are set and in response, the digital interface generator 260 may enable the sliding button 448 to be selectable by the operator.

The universal vehicle control router 120 may use one or more voters (e.g., FAT voters 230) to determine a validity of an actuator instruction provided to the engine. As described with reference to the FAT voters 230 in the description of FIG. 2, a FAT voter may determine whether a corresponding flight control computer is malfunctioning and in response to determining that the computer is malfunctioning, stop the transmission of instructions to an actuator (e.g., an actuator coupled to an engine). For example, the FAT voter may determine that a flight control computer is malfunctioning, which may negatively affect the accuracy of the pre-start engine parameters and/or post-start engine parameters, and in response, stop the transmission of instructions to an engine (e.g., prevent a control module from starting the engine because the accuracy of pre-start engine parameters may be compromised).

FIG. 6 shows the aerial vehicle and trip configuration interface 420B and the navigation configuration interface 440B of the GUI 400 during an engine startup performed by a vehicle control and interface system, in accordance with one embodiment. The display window 423 of the aerial vehicle and trip configuration interface 420B is updated by the digital interface generator 260 in response to an operator selecting the sliding button 448 to start an engine of the aerial vehicle. The updated display window 423 may show a progress indicator of the automated engine startup that the vehicle control and interface system 100 is performing in the background. The startup may include determining a set of post-start engine parameters such as an engine torque, a rotational speed of an engine compressor, or a measured gas temperature (MGT) of the engine. The universal vehicle control router 120 may perform a set of pre-start engine checks and a set of post-start engine checks, where the pre-start engine parameters characterize the outcomes of the performed set of pre-start checks and the post-start engine parameters characterize the outcomes of the performed set of post-start checks.

The universal vehicle control router 120 may receive measurements from sensors on aerial vehicle (or aerial vehicle sensors) or instruct actuators of the aerial vehicle with instructions to perform a check. For example, the universal vehicle control router 120 may instruct an engine to increase an RPM before measuring whether an engine oil temperature, an example of a post-start engine parameter, has reached a target value to satisfy an operation criteria. Examples of operation criteria include conditions such as a temperature of engine oil being within a predetermined range for a predetermined duration of time. Additional examples of operation criteria include a series of conditions such as oil pressure of the engine meeting a target oil pressure within a first predetermined duration of time since starting the engine of the aerial vehicle and then maintaining the oil temperature at a target oil temperature for a second predetermined duration of time after the engine is operated at a predetermined rotations per minute. In some embodiments, in response to determining that one or more operation criteria used to evaluate post-start engine parameters have not been satisfied, the universal vehicle control router 120 may abort engine startup (e.g., stop the engine of the aerial vehicle). The universal vehicle control router 120 may monitor various engine sensors and if values measured at the sensors are not within the correct ranges within a certain time, the universal vehicle control router 120 may automatically abort the engine start. The digital interface generator 260 may display controls for an operator to abort an engine start at will.

The digital interface generator 260 may update the display window 423 to include a virtual touchpad through which user input controls for one or more navigational controls can be input. The navigational controls can include a speed, heading, or altitude of the aerial vehicle. The user input controls may be finger gestures such as a swipe with one finger, multiple fingers, a rotational swipe in a circle, a user defined gesture, any suitable gesture of one or more fingers on a virtual touchpad, or a combination thereof. In some embodiments, the digital interface generator 260 may perform this update in response to determining that a set of post-start engine parameters safety a set of operation criteria. That is, the digital interface generator 260 may prevent the user from specifying instructions for operating the aerial vehicle until the universal vehicle control router 120 determines that the aerial vehicle is safe to operate.

The digital interface generator 260 may generate a remote assistance request control for display at the GUI 400. For example, the digital interface generator 260 can generate a button on the aerial vehicle and trip configuration interface 420B or 440B that, in response to selection by an operator, may cause the universal vehicle control router 120 to transmit a request to a ground-based computer system. The request may provide authorization for a remote operator at the ground-based computer system to remotely access the displayed information and the input controls of the GUI 400. The universal vehicle control router 120 may also cause communication tools within the aerial vehicle to communicatively couple to the ground-based computer system so that an operator in the aerial vehicle may speak with the remote operator. In one example, the remote operator may assist the operator during the engine startup, guiding the operator through the various manually-verified engine start controls and remotely selecting the check boxes when the operator has confirmed verbally that the checks have been complete. In another example, the remote operator may assist the operator during flight, providing input of the navigational controls via the GUI 400 to control the aerial vehicle remotely (e.g., during an emergency event where landing assistance is needed).

During engine startup, the universal vehicle control router 120 may implement various accuracy or redundancy checks to promote safety of aerial vehicle operation. The universal vehicle control router 120 may implement these checks for pre-start engine parameters, post-start engine parameters, or a combination thereof. The universal vehicle control router 120 may compare one type of measurement taken by different sensors, compare multiple measurements taken by the same sensor over time, or compare measurements to historical or predicted measurements to determine an accuracy of the measurements. In some embodiments, the universal vehicle control router 120 may apply machine learning to determine a likely value of a pre-start or post-start engine parameter. For example, a machine learning model may be trained using historical values of a post-start engine parameter (e.g., oil temperature) and corresponding parameters related to the historical operation of the aerial vehicle (e.g., RPM of the engine, the type of aerial vehicle, the time of year, outside air temperature, weather conditions, etc. when the historical oil temperature was measured) to determine a likely value of a post-start engine parameter based on measured parameters related to a current operation of the aerial vehicle.

FIG. 7 is a flowchart of a process 700 for determining an aerial vehicle is ready for flight through automated engine startup checks, in accordance with one embodiment. The process 700 may be performed by the vehicle control and interface system 100 processing system. The processing system is a computer processing system configured to operate as specified by the vehicle control and interface system 100. The process 700 may have additional, fewer, or different operations.

The vehicle control and interface system 100 is configured to generate 710 a GUI that includes aerial vehicle monitor graphics which provide a pilot of an aerial vehicle with status information related to operations of the aerial vehicle. The digital interface generator 260 may generate 710 a GUI such as the GUI 400 with aerial vehicle monitor graphics such as the gauges 445, 446, or 447. The vehicle control and interface system 100 measures 720 pre-start engine parameters. The universal vehicle control router 120 may receive measurements from aerial vehicle sensors, where the received measurements include pre-start engine parameters such as a brake engagement state. The vehicle control and interface system 100 determines 730 whether a first set of operational criteria (e.g., engine components (electrical, mechanical), safety, regulatory) are satisfied by the pre-start engine parameters. For example, the universal vehicle control router 120 may determine that a brake engagement state indicates whether the brakes are set. In response to determining 730 that the first set of operational criteria have not been satisfied, the vehicle control and interface system 100 may return to measure 720 pre-start engine parameters or although not depicted, may additionally prevent the engine from starting. For example, the digital interface generator 260 may prevent interactions with a user input control (e.g., the sliding button 448) from providing an instruction for the engine to start.

In response to determining that the first set of operational criteria are satisfied by the pre-start engine parameters, the vehicle control and interface system 100 starts 740 the engine of the aerial vehicle. A control module of the universal vehicle control router 120 may generate an instruction for an engine to start (e.g., signal engine controller). For each of a set of computers (e.g., flight control computers), the vehicle control and interface system 100 measures 750 post-start engine parameters using sensors of the aerial vehicle. The universal vehicle control router 120 may receive measurements from aerial vehicle sensors, where the received measurements include post-start engine parameters such as an engine oil temperature. The vehicle control and interface system 100 verifies 760 that one or more of the post-start engine parameters satisfy an accuracy criterion. The universal vehicle control router 120 may verify 760 that a measured engine oil temperature satisfies an accuracy criterion that temperature measurements from multiple temperature sensors fall within a threshold range of values. The vehicle control and interface system 100 modifies 770 one or more of the aerial vehicle monitor graphics of the GUI to reflect the verified post-start engine parameters. For example, the digital interface generator 260 may modify 770 one or more of the gauges 445, 446, or 447 to reflect the measured and verified post-start engine parameters such as the engine oil temperature. The vehicle control and interface system determines 780 whether a second set of operational criteria are satisfied by the verified post-start engine parameters. In response to determining that the second set of operational criteria are not satisfied, the vehicle control and interface system can return to measure 750 post-start engine parameters (e.g., to reduce the likelihood of false negative measurements) or although not depicted, prevent the pilot of the aerial vehicle from operating the aerial vehicle. For example, the digital interface generator 260 may disable user input controls that enable the operator to control the navigation of the aerial vehicle.

In response to determining 780 that the second set of operational criteria are satisfied by the verified post-start engine parameters, the vehicle control and interface system 100 may generate 790 a status indicator for display at the GUI that indicates that the aerial vehicle is ready for flight. The universal vehicle control router 120 may determine 780 that the verified engine oil temperature satisfies an operation criterion that the oil temperature be within a predetermined range of values for a predetermined duration of time (e.g., the oil temperature is within 38-66 degrees Celsius or approximately 100-150 degrees Fahrenheit for 120 seconds after the engine starts). The digital interface generator 260 may then generate 790 a touchpad interface at the navigation configuration interface 440 that enables the pilot of the aerial vehicle to increase the engine speed to cause the aerial vehicle to take off.

### Example Navigation Using the Vehicle Control and Interface System

Referring now to FIGS. 8-18, various example interfaces and methods for controlling navigation for an aerial vehicle are described. The vehicle control and interface system 100 may generate each example interface. The vehicle control and interface system 100 may generate alternative or additional interfaces. The interfaces depicted in FIGS. 8-17 refer back to the GUI 400 of FIG. 4, depicting various embodiments of one or more of the subsections 410, 420, 430, or 440.

FIG. 8 shows the navigation configuration interface 440C of the GUI 400 during a selection of a COM frequency, in accordance with one or more embodiments. An operator of the aerial vehicle may select a COM frequency to receive information from or communicate with air traffic control services such as an airport control tower, approach and terminal control, or area control center. The navigation configuration interface 440C includes the COM frequency dashboard 441, the navigational control menu 442, and the navigational control window 443. An operator may view COM frequencies to which one or more radios of the aerial vehicle may be tuned in the COM frequency dashboard 441. The operator may select a frequency displayed in the COM frequency dashboard 441, providing a request through the GUI 400 to the digital interface generator 260 to display user inputs (e.g., in the navigational control window 443) for modifying the selected frequency.

In the embodiment shown in FIG. 8, the digital interface generator 260 has generated an interface for an operator to select a COM frequency. For example, in response to the operator selecting a frequency displayed at the COM frequency dashboard 441, the digital interface generator 260 updates the content of the navigational control window 443 from an engine start up interface (e.g., FIG. 5) to a frequency selection interface as shown in FIG. 8. The navigational control window 443 includes a favorites interface 800 of frequencies stored by the universal vehicle control router 120 based on instructions provided by the operator. These stored frequencies may be stored in a user profile associated with the operator, and the user profile may be stored within the data store 150. Example frequencies shown in the favorites interface 800 include control tower frequencies for airports in, for example, San Francisco, Palo Alto, Oakland, Los Angeles, Long Beach, and Camarillo. The frequencies displayed at the COM frequency dashboard 441 include a control tower frequency for Camarillo Airport (CMA) and the automatic terminal information service (ATIS) frequency for CMA.

The universal vehicle control interfaces 110 can include various interfaces enabling an operator to request a particular frequency to which to tune a radio of the aerial vehicle. The interfaces for radio frequency input (COM and/or NAV frequencies) may include an electronic display at which a GUI generated by the digital interface generator 260 is displayed, a controller stick for selecting a frequency that is displayed at a GUI, a physical number pad, any suitable input for a frequency number, or a combination thereof. The digital interface generator 260 generates user input controls in the navigation configuration interface 440C that enable an operator to specify COM frequencies to which a flight control computer may instruct one or more radios of the aerial vehicle to tune. The user input controls of the GUI may include a number pad, as shown in FIG. 8, a virtual touch pad through which the operator may draw numbers for a desired frequency, any suitable displayable input control for submitting numbers for a desired frequency, or a combination thereof.

The universal vehicle control router 120 may enable manual change of radio frequencies or automatically change the radio frequencies. An operator may interact with the user inputs displayed at the navigation configuration interface 440C (e.g., tapping a touch screen) to manually change a radio frequency. In some embodiments, the universal vehicle control router 120 may use the location (e.g., GPS coordinates) or distance measurement (e.g., an altitude of the aerial vehicle) as measured by aerial vehicle sensors, navigational state of the aerial vehicle (e.g., a flight control computer is performing an automated landing of the aerial vehicle), or any suitable characteristic of the aerial vehicle's operation during which communication via a radio frequency is used, to determine a frequency to which to tune a radio of the aerial vehicle. For example, when preparing an aerial vehicle for takeoff, the universal vehicle control router 120 may tune a COM radio to an ATIS frequency of an airport at which the aerial vehicle is located in response to determining, using GPS data, that the aerial vehicle is located at the airport and determining, using an altimeter reading, that the aerial vehicle is still on the ground. In another example, the universal vehicle control router 120 may change the COM frequency at which a radio of the aerial vehicle is tuned from the frequency of the Los Angeles Air Route Traffic Control Center (ARTCC) to the control tower frequency for CMA as the operator prepares to descend into CMA. The digital interface generator 260 may update the navigation configuration interface 440C to display the changed radio frequency.

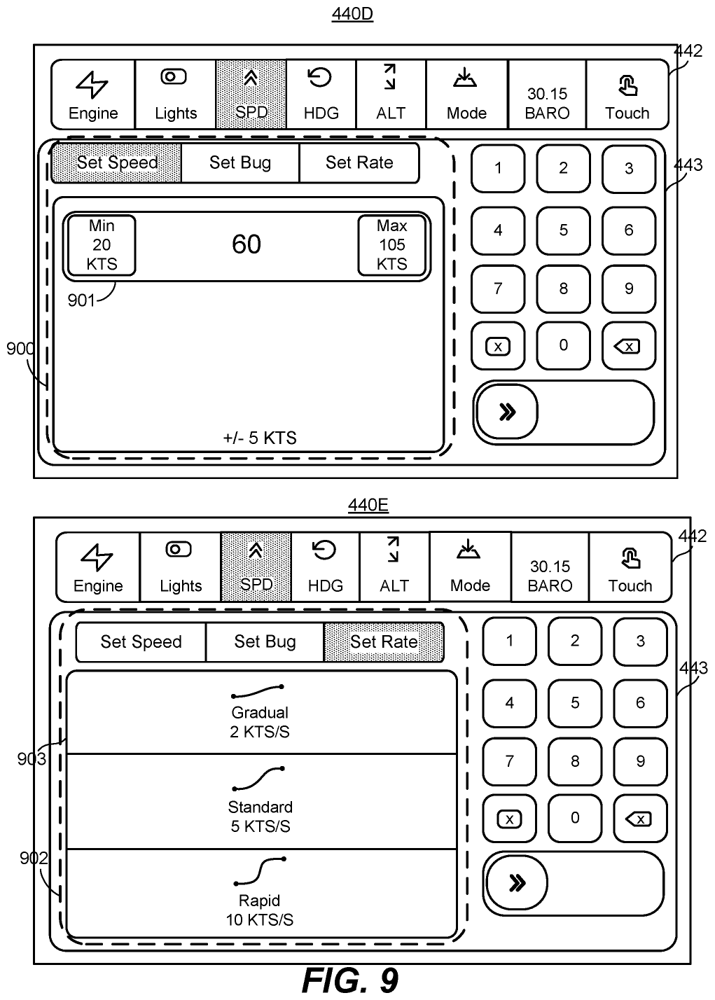

FIG. 9 shows configurations of navigation configuration interface 440 of the GUI 400 when selecting a speed of the aerial vehicle, in accordance with one or more embodiments. An operator may select the SPD icon in the navigational control menu 442 to view or change a speed at which the aerial vehicle is operating. In response to selecting the SPD icon, the digital interface generator 260 may cause the content of the navigational control window 443 to display user control inputs for setting a speed of the aerial vehicle, a speed bug for display at a speed indicator, or an acceleration rate at which the aerial vehicle causes an actuator (e.g., an actuator coupled to an engine) to reach the set speed. The digital interface generator 260 may display recommended speeds, bugs, or acceleration rates based on previous operator selections or determinations using models (e.g., a machine learning model to determine a recommended aerial vehicle speed or acceleration rate based on measurements taken by the aerial vehicle sensors and/or the operator's previous selections).

The navigation configuration interface 440D shows a speed selection interface 900 within the navigational control window 443. The digital interface generator 260 may generate the speed selection interface 900 in response to an operator selecting a menu icon (e.g., the Set Speed button) or automatically in response to a control module of the universal vehicle control router 120 determining that a speed is needed for navigation. For example, the digital interface generator 260 may automatically generate the speed selection interface 900 in response to determining that the engine startup checks have been completed and the user is preparing the aerial vehicle for takeoff. The digital interface generator 260 generates a speed setting indicator 901 that displays a minimum speed (e.g., 20 knots) of the aerial vehicle, a maximum speed (e.g., 105 knots) of the aerial vehicle, and a requested speed (e.g., 60 knots). The digital interface generator 260 may generate a number pad, as shown in FIG. 9, a virtual touchpad (e.g., for the user to draw a number on a touch screen of the universal vehicle control interfaces 110), any suitable input control for the operator to provide a number for the requested speed, or a combination thereof. The universal vehicle control router 120 may enable an operator to set one or more of the minimum or maximum speeds subject to engine performance limitations or safety protocols. The speeds selected by the operator may be reached at an acceleration or deceleration rate that the operator also sets.

The navigation configuration interface 440E shows an acceleration rate selection interface 902 within the navigational control window 443. The digital interface generator 260 may generate the acceleration rate selection interface 902 in response to the operator selecting a menu icon (e.g., the Set Rate button) generated by the digital interface generator 260 or automatically in response to a control module of the universal vehicle control router 120 determining that the operator has finished selecting a previous navigational setting (e.g., after the operator has selected a desired speed via the speed selection interface 900). The acceleration rate selection interface 902 includes an acceleration menu listing various rates or patterns of rates for accelerating the aerial vehicle to a speed requested by the operator. As depicted in FIG. 9, three acceleration rates are shown: gradual (e.g., two knots/second), standard (five knots/second), and rapid (ten knots/second). The universal vehicle control router 120 may use a pattern of rates to accelerate the aerial vehicle (e.g., 2 KTS/S for 30 seconds, then 5 KTS/S for 20 seconds, and followed by 2 KTS/S for 10 seconds). The operator may set a rate or pattern of rate through user input controls generated for display by the digital interface generator 260. Example user input controls include a number pad, a touch pad (e.g., to draw a curving line corresponding to a desired rate of acceleration and/or deceleration), or a combination thereof.

By providing a selection interface for a rate of change in a navigational setting (e.g., rate of speed increase or decrease) with a visual depiction of that rate of change rather than requiring an operator to select numbers without a visual depiction of how the numbers may translate when operated in sequence, the digital interface generator 260 lowers the mental load upon an operator and provides additional information about the selected rate of change that may help the operator be in greater control of their navigational choices. In turn, the vehicle control and interface system 100 reduces the error that may occur during operation and increases the safety of operating an aerial vehicle.

Although not depicted, selection interfaces may be generated by the digital interface generator 260 for aerial vehicle navigational settings such as heading and altitude. For example, an operator may select the HDG or ALT buttons at the navigational control menu 442 to instruct the universal vehicle control router 120 to change an aerial vehicle's heading or altitude, respectively. The digital interface generator 260 may generate user input controls similar to those displayed in FIG. 9 for changing other navigational settings such as heading and altitude. Additionally, the universal vehicle control router may generate instructions for selecting navigational settings and changing rates at which the navigational settings are achieved by actuators of the aerial vehicle (e.g., heading change rates in degrees per second or altitude change rates in feet per minute).

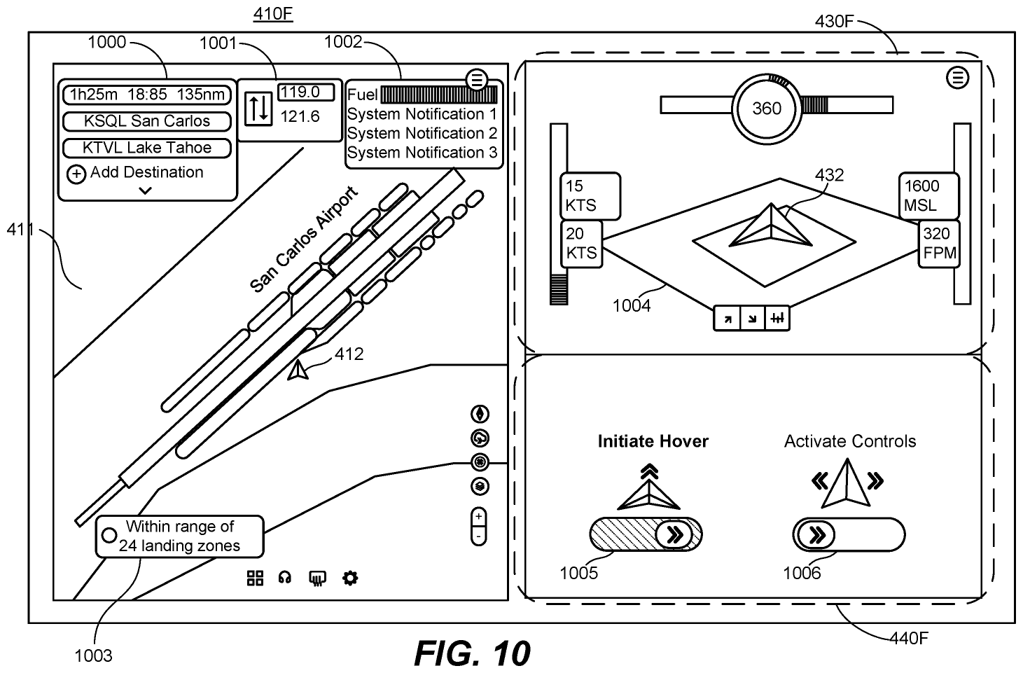

FIG. 10 shows configurations of the trip visualization interface 410 and the navigation visualization interface 430 as the aerial vehicle is beginning takeoff, in accordance with one or more embodiments. The universal vehicle control router 120 provides data for the interfaces 410F and 430F to enable the operator to view the environment of the aerial vehicle during takeoff and instruct the aerial vehicle to begin takeoff. The universal vehicle control router 120 may additionally provide data for the interfaces during other or all portions of a flight (i.e., from takeoff to landing). In some embodiments, the digital interface generator 260 may generate the GUI 400 in three subsections. In FIG. 10, the two subsections are depicted by the trip visualization interface 410F occupying the left side of an electronic display and the navigation visualization interface 430F and the navigation configuration interface 440F occupying the right side of the electronic display.

The trip visualization interface 410F provides information about the aerial vehicle's location and the trip to be taken by the aerial vehicle. The digital interface generator 260 generates the map 411 to enable the operator to view the current location of the aerial vehicle on a roadmap. The map 411 within the trip visualization interface 410F depicts the avatar 412 of the aerial vehicle and one or more airports, including available travel routes or boarding and maintenance areas within a given airport (e.g., taxiways, runways, aprons/ramps, heliports, etc.). The digital interface generator 260 generates information panels 1000-1002. While the information panels 1000-1002 are depicted as included within the trip visualization subsection 410F, the information panels 1000-1002 may be displayed in different areas of an interface. The trip information panel 1000 includes trip information such as the duration of the trip, estimated time of arrival, distance of the trip, an origin and destination of the trip, etc. The navigation radio panel 1001 includes radio information such as the NAV frequencies to be used during the trip. The system information panel 1002 includes system information such as information describing the state of the aerial vehicle (e.g., fuel levels) and notifications describing the state of the aerial vehicle as determined by the universal vehicle control router 120. The digital interface generator 260 may generate a landing zone notification 1003 for display informing the operator of information describing landing zones within a vicinity of the aerial vehicle. The universal vehicle control router 120 may determine the landing zones within the vicinity of the aerial vehicle based on the aerial vehicle's location (e.g., as determined by GPS) and a vicinity threshold (e.g., twenty nautical miles).

The navigation visualization interface 430F provides navigational information such as the attitude of the aerial vehicle, speed, altitude, heading, etc. The digital interface generator 260 generates a flight display showing the avatar 432 of the aerial vehicle from a third-person perspective as it is beginning to hover over a landing area 1004. The aerial vehicle depicted in FIG. 10 may be a helicopter or any suitable passenger aerial vehicle configured to hover. The navigation configuration interface 440F provides user input controls for an operator of the aerial vehicle to request that the aerial vehicle begin hovering. The digital interface generator 260 generates a sliding button 1005 configured to, in response to an operator's selection of the sliding button 1005, cause the digital interface generator 260 to transmit instructions to a control module for initiating a hover or stopping a hover (e.g., swiping in one direction activates a hover and swiping in another direction deactivates the hover and brings the aerial vehicle to the ground). In some embodiments, after the aerial vehicle begins to hover, the universal vehicle control router 120 may prepare the aerial vehicle for takeoff using the speed, heading, and/or altitude settings selected by the operator via the user input controls in the navigation configuration interface 440D and 440E. The digital interface generator 260 generates a sliding button 1006 configured to, in response to an operator's selection of the sliding button 1006, cause the digital interface generator 260 to transmit instructions to a control module for activating or deactivating navigational controls of the aerial vehicle, depending on the direction that the operator slides the sliding button 1006. In response to receiving a user selection via the sliding button 1006 activating navigational controls, the digital interface generator 260 may update the user input controls displayed on the navigation configuration interface 440F to include user input controls for various navigational controls (e.g., heading, speed, altitude, etc.). An example of input controls for navigational controls is depicted in FIG. 11.

FIG. 11 shows the navigation visualization interface 430G and the navigation configuration interface 440G during navigation of an aerial vehicle in flight, in accordance with one or more embodiments. The digital interface generator 260 generates the flight display in navigation visualization interface 430G that includes the avatar 432 of the aerial vehicle, a heading indicator 436, an airspeed indicator 434, a vertical speed indicator 435, and a horizon line 437. The digital interface generator 260 generates a current speed indicator 1101, a requested speed indicator 1102, a maximum speed indicator 1100, and a minimum speed indicator 1103. The digital interface generator 260 may receive a speed setting specified by the operator (e.g., using the navigation configuration interface 440D or the navigation configuration interface 440E) and provide the operator's instruction to a flight control computer to operate one or more actuators to act upon the operator's instruction. The digital interface generator 260 generates a current altitude indicator 1105, a requested altitude acceleration indicator 1106, a maximum altitude indicator 1104, and a minimum altitude indicator 1107. The digital interface generator 260 may receive an altitude setting specified by the operator and provide the operator's instruction to a flight control computer to operate one or more actuators to act upon the operator's instruction. The flight display may include a representation of the environment around the aerial vehicle, including the fixed horizon line 437. The representation of the environment may be simplified for improved comprehensibility of the aerial vehicle's attitude. In some embodiments, the representation of the environment may include a representation of the surface of the earth absent shapes of land and objects located on the surface of the earth. For example, the sky may be represented by one color while the earth's surface is represented by another color.

The digital interface generator 260 generates attitude indicators 1108 and 1109 describing an attitude of the aerial vehicle (e.g., in substantially real time as tracked by aerial vehicle sensors such as gyros). As referred to herein, where values are described as “approximate” or “substantially” (or their derivatives, such values should be construed as accurate+/−a predefined value considered to be within an acceptable operational range (e.g., 10%) unless another meaning is apparent from the context. For example, a GUI tracking aerial vehicle movement in substantially real time may refer to the display of information related to the aerial vehicle movement that reflects the current movement of the aerial vehicle with at most a 0.1 second delay. The attitude indicator 1108 may be displayed to be parallel to the surface of the earth or may indicate an angle of the airplane as it is maintaining level flight (e.g., a level angle of the longitudinal axis). In some embodiments, the attitude indicator 1108 and the horizon line 437 may be fixed (e.g., the avatar 432 is rotating but the horizon line 437 and attitude indicator 1108 are not moving). The attitude indicator 1109 may indicate a current angle of one or more of the lateral axis or the longitudinal axis of the aerial vehicle. The digital interface generator 260 may modify the attitude indicator 1109 in response to receiving a user interaction with the navigation configuration interface 440G. For example, the operator performs a finger gesture on a touch screen display over the navigation configuration interface 440G to change the heading of the plane, the universal vehicle control router 120 generations and provides instructions that cause the actuators of the aerial vehicle to change the aerial vehicle's heading to the requested heading, and the digital interface generator 260 modifies the display of the attitude indicator 1109 to follow the aerial vehicle's lateral axis as the aerial vehicle is maneuvering to fly in the direction of the user's requested heading. The attitude indicators 1108 and 1109 are depicted as concentric circles centered at the avatar 432 of the aerial vehicle. The attitude indicators generated by the digital interface generator 260 may be any suitable shape or form and are not necessarily limited to circles centered at the avatar of the aerial vehicle.

Existing navigation displays may generate attitude indicators as numerical values (e.g., a degree in which the aerial vehicle is rotated about its longitudinal axis) or at a different location from an avatar of the aerial vehicle (e.g., at a corner of the display). By generating attitude indicators that are visual representations of numerical values, the digital interface generator 260 reduces the mental load on an operator to convert a numerical value into a physical effect on the aerial vehicle's orientation during flight. Furthermore, by generating attitude indicators in a location at the GUI that is closer to the avatar of the aerial vehicle, the digital interface generator 260 reduces the distance that an operator's eye may be required to travel to understand the attitude of the aircraft and increases a visual correlation between the avatar and the attitude indicators, which both in turn lower the mental load on the operator. Lowering the mental load on the operator also reduces a chance of error during operation of the aerial vehicle, improving the safety of operating the aerial vehicle.

The navigation configuration interface 440G shows example user input controls for controlling the navigation of an aerial vehicle during flight. A touch screen interface of the universal vehicle control interfaces 110 may be used to receive an operator's finger gestures against a virtual touchpad generated by the digital interface generator 260 in the navigation configuration interface 440G. The finger gestures may include interactions with the interface on a screen that includes a number of fingers, direction of movement for a gesture, and/or touch frequency with the interface (e.g., one or more taps and time intervals between consecutive taps). Examples of finger gestures are described herein.

The digital interface generator 260 may generate for display visual feedback at a touch screen interface in response to an operator touching the touch screen interface. For example, the digital interface generator 260 may generate for display a partially transparent white circle where an operator is currently touching the touch screen interface. The visual feedback may indicate to the operator which gesture is being performed. For example, the digital interface generator 260 may generate for display three white lines that track an operator's three fingers as they swipe against the touch screen interface.

Examples of finger gestures include a swipe of a finger in a straight line, a swipe of a finger in a circle, a swipe of multiple fingers in a straight line, a rotation with two fingers, or a combination thereof. The digital interface generator 260 may generate a guide for available finger gestures, including a speed finger gesture guide 1111, a lateral finger gesture guide 1112, a heading finger gesture guide 1113, and a vertical finger gesture guide 1114. The speed finger gesture guide 1111 demonstrates that, to change the airspeed of the aerial vehicle, the operator may swipe a single finger up (e.g., to increase the speed). Although not depicted, the digital interface generator 260 may similarly display a guide instructing the operator how to change the airspeed in other ways (e.g., to decrease the speed). The arrow 1115 reflects this motion of the operator's hand 1110 to change the airspeed. The lateral finger gesture guide 1112 demonstrates that, to move the lateral axis of the aerial vehicle counterclockwise (e.g., rotating about the longitudinal axis), the operator may swipe a single finger towards the left. Although not depicted, the digital interface generator 260 may similarly display a guide instructing the operator how to change the lateral axis of the aerial vehicle in other ways (e.g., swiping the finger to the right to tilt the wings clockwise). The heading finger gesture guide 1113 demonstrates that, to change the heading of the aerial vehicle in a counterclockwise direction, the operator may hold one finger at the touch screen while a second finger encircles the first finger in a counterclockwise direction. Although not depicted, the digital interface generator 260 may similarly display a guide instructing the operator how to change the heading of the aerial vehicle in other ways (e.g., swiping the second finger clockwise to change the heading in a clockwise direction). The vertical finger gesture guide 1114 demonstrates that, to change the vertical speed (e.g., the altitude acceleration) of the aerial vehicle, the operator may swipe three fingers simultaneously in one direction (e.g., to increase the speed). Although not depicted, the digital interface generator 260 may similarly display a guide instructing the operator how to change the vertical speed in other ways (e.g., swiping down to decrease the speed). The digital interface generator 260 may be configured to receive additional finger gesture instructions than are displayed in FIG. 11.

The digital interface generator 260 may display a subset of the available finger gesture instructions (e.g., the most commonly used finger gesture instructions). The digital interface generator 260 may provide a manual for display with guides for available finger gestures. In some embodiments, the digital interface generator 260 may enable an operator to specify custom finger gestures for a navigational setting. For example, the digital interface generator 260 generates a prompt for display requesting the navigational setting and corresponding finger gesture along with a virtual touchpad for the operator to input the corresponding finger gesture. A flight control computer may then store the customized finger gesture mapped to the navigational setting under a profile for the operator (e.g., in the data store 150).

The universal vehicle control router 120 may determine that an operator is canceling an instruction for changing the navigation of the aerial vehicle. In some embodiments, the universal vehicle control router 120 may determine that a particular finger gesture at a touch screen of the universal vehicle control interfaces 110 indicates that the operator is requesting to stop a navigation instruction currently executed by one or more actuators of the aerial vehicle. For example, the universal vehicle control router 120 may determine that multiple taps in succession (e.g., a double tap) against the virtual touch pad is the operator providing instructions to stop a currently executed navigational instruction (e.g., stop the aerial vehicle from increasing its speed or altitude).

In one example embodiment, the system may preprogram certain gestures and/or rapid interactions, e.g., tap or taps on touchpad, to correspond to specific commands. The gestures and/or rapid interactions on the touch pad are translated as signals for the processor system to process via the universal vehicle control router 120. An FCC further translates the received commands to have the aircraft components, e.g., actuators, to perform specific actions corresponding to what the pilot intended with the gesture and/or rapid interaction. The gestures and/or rapid interactions may include permutations that take into account the number of fingers of a pilot that are applied to the touch pad. For example, two finger rapid tap with a single finger swipe may be one command, a three finger rapid tap with a two finger swipe may be a second command, and a two finger rapid tap with a two finger swipe may be a third command. Hence, the number of potential commands enabled may can be significantly increased based number fingers (including thumb) applied as well as combination applied (e.g., just gesture or rapid interaction or both together).

By way of example, a rapid double tap with two fingers followed by a two finger gesture from right to left on the touch pad may correspond to the two finger rapid tap triggering a banked turn command followed by the two finger swipe direction corresponding to the turn direction, e.g., here to the left. This signal is transmitted back to the flight operation system that, in turn, signals the aircraft components to configure to engage a banked turn to the left. Further by example, three finger rapid tap may followed by a two finger swipe from bottom to top of touch pad (e.g., up direction) may correspond to the three finger rapid tap triggering a command to change altitude and the two finger swipe up direction corresponding to an increase of altitude. An FCC can store in memory a running list of commands as they are entered by a pilot. The memory may be configured to store in a log a predetermined set of recent command, e.g., twenty most recent, or may be configured to store all commands until the flight is completed. Further, the commands received may further be stored, e.g., in a database log, in longer term storage.

In some example embodiments, rapid cancellation of a command may be desired. Often, there is no mechanism to cancel previously provided commands, but rather new actions must be taken to override prior commands. The disclosed configuration allows for rapid cancellation of a command through a double tap action on the touch pad. In one example embodiment, a double tap to cancel command receives a rapid double tap (e.g., very short time sequence consecutive taps) that corresponds to the command sought to be canceled. Using the prior example, if the pilot sought to cancel the banked turn, the pilot would perform a rapid double tap with two fingers on the touch pad. A signal corresponding to this action that included detection of the two fingers is transmitted to the processing system and FCC. The two finger double tap confirmed as mapped to a banked turn and the system identifies within the stored log that the last banked turn was to the left. To cancel the turn to the left and update the heading for the aircraft to the now new the travel path vector, the FCC transmits signals to the corresponding aircraft actuators to update the heading for the aircraft. Also using the prior example, if the action to be canceled was the altitude change of the aircraft, the pilot performs a rapid double tap on the touchpad with three fingers. The rapid double tap and three fingers are detected and a signal corresponding to what was detected on the touch pad are sent back to the processing system and flight operation system. The FCC determines that the three fingers detected corresponds to altitude change and that the log action was for a rise in altitude. The flight operating system generates a signal for the actuators that adjusts the actuators so that the aircraft no longer is climbing and is leveling out on its flight vector.

By implementing finger gestures to receive instructions for controlling navigation of an aerial vehicle, vehicle control and interface system 100 reduces the mental load upon an operator of the aerial vehicle. To specify a navigational instruction (e.g., changing a heading) in conventional aerial vehicle navigation interfaces, an operator may be required to operate multiple control inputs (e.g., mechanical controller sticks, buttons, switches, levers, etc.) to engage respective actuators of the aerial vehicle. The vehicle control and interface system 100 may receive a finger gesture made upon a touchpad, which is a single operation rather than operating multiple control inputs, and automatically determine which actuators of the aerial vehicle to engage to effect change in the navigation of the aerial vehicle.

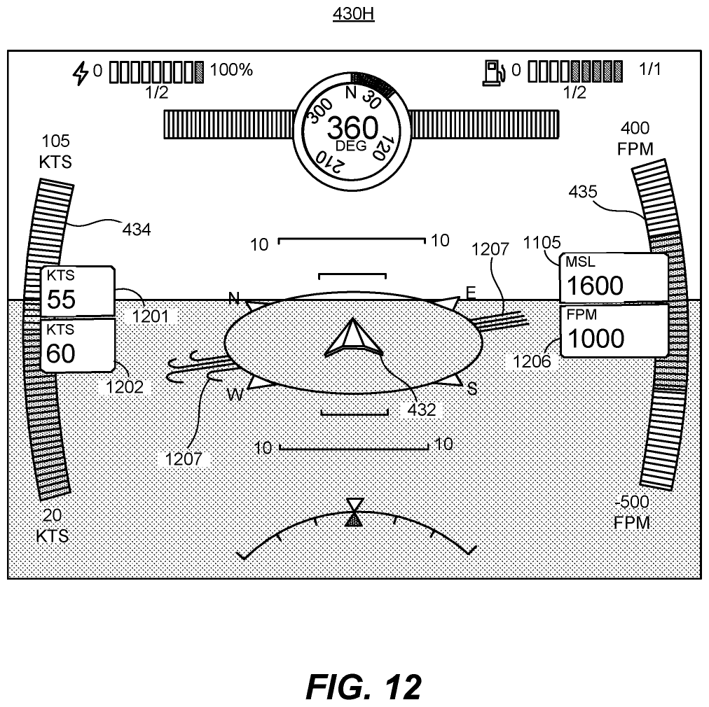

FIG. 12 shows a flight display in the navigation visualization interface 430H during flight, in accordance with one or more embodiments. The flight display includes the airspeed indicator 434, the vertical speed indicator 435, a current airspeed indicator 1201, a requested airspeed indicator 1202, a current altitude indicator 1205, and a requested altitude acceleration indicator 1206. In some embodiments, the digital interface generator 260 may generate a requested altitude indicator in addition to or as an alternative to the requested altitude acceleration indicator 1206. The digital interface generator 260 generates a wind indicator 1207 for display. The wind indicator 1207 is drawn proximal to the avatar 432 of the aerial vehicle. In particular, the avatar 432 bisects a representation of the wind as straight lines that curve towards the direction that the wind is traveling (e.g., from approximately east to west), where the wind indicator 1207 includes this representation. The depiction of the wind indicator 1207 proximal to the aerial vehicle's avatar 432 may assist an operator in navigating the plane towards headwind due to the fewer eye movements needed compared to a wind indicator that is located at a corner of the display or has a small size.

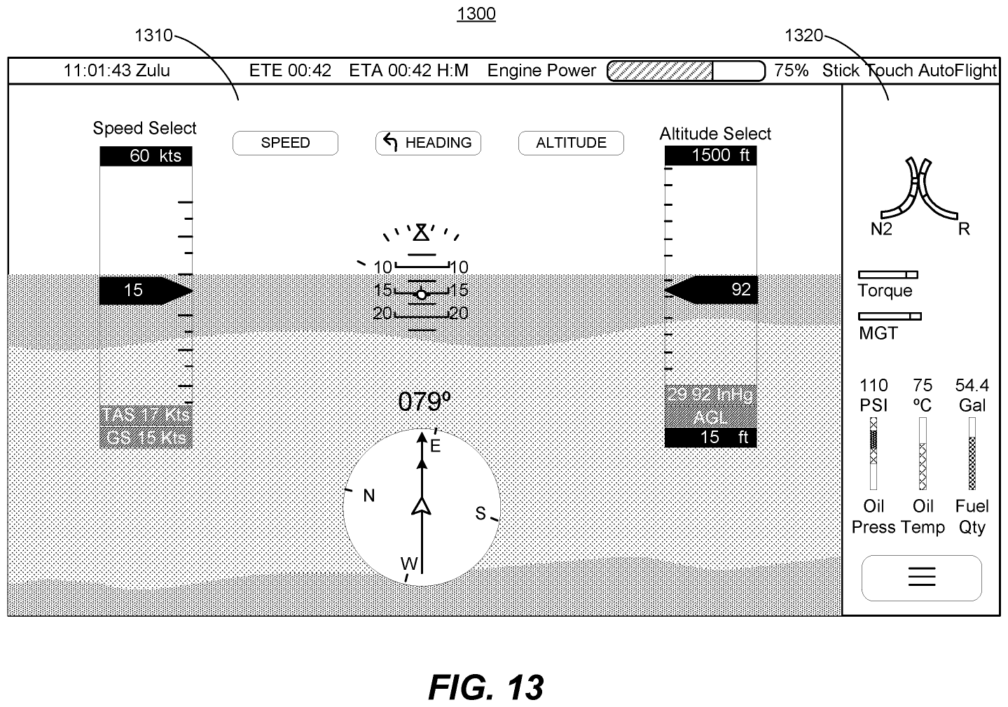

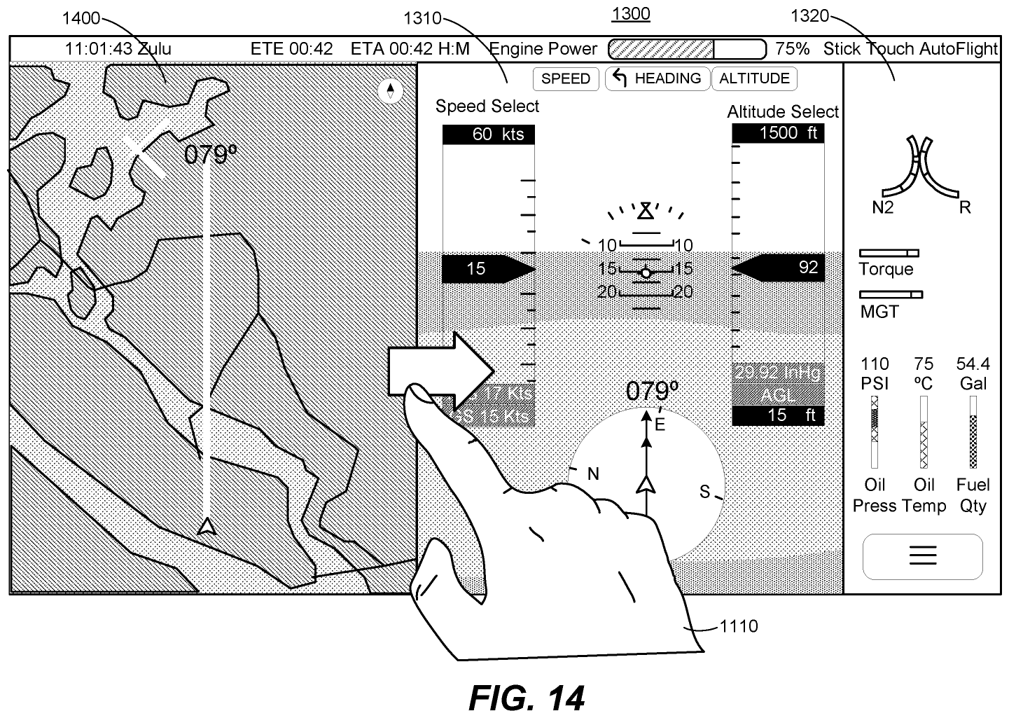

FIG. 13 shows a GUI 1300 generated by the vehicle control and interface system at an electronic display of an aerial vehicle during flight, in accordance with at least one embodiment. The GUI 1300 may be generated by the digital interface generator 260. The GUI 1300 may be displayed on a display (e.g., the primary vehicle control interface 320, the multi-function interface 330, or the touch screen interface described with respect to FIGS. 21-28). The GUI 1300 may have similar components to the GUI 400 of FIG. 4. The GUI 1300 includes a navigation visualization interface 1310 and a navigation configuration interface 1320. An operator the aerial vehicle may reposition or change the sizes of the interfaces 1310 and 1320. For example, the operator may minimize the navigation configuration interface 1320 to remove it from view on the GUI 1300, causing the navigation visualization interface 1310 to occupy the entirety of the green. In some embodiments, the GUI 1300 may be capable of displaying additional interfaces that are not depicted in FIG. 13. That is, the controller may interact with the display hardware to request the display of an additional interface. One example is described with respect to FIG. 14.

FIG. 14 shows the GUI 1300 with an additional trip visualization interface 1400, in accordance with at least one embodiment. An operator's hand 1110 may interface with a touch screen interface displaying the GUI 1300 to request that the trip visualization interface 1400 be displayed next to the navigation visualization interface 1310. As depicted in FIG. 14, the operator's hand swipes from the left of the screen towards the right to instruct the digital interface generator 260 to display the navigation visualization interface 1310. For example, beginning from the configuration shown in FIG. 13, the operator's hand 1110 may swipe from the left edge of the touch screen towards the right to result in the configuration shown in FIG. 14. The configuration shown in FIG. 13 may be referred to as a “full view” and the configuration shown in FIG. 14 may be referred to as a “split view.” In another example, the operator's hand 1110 may minimize the trip visualization interface 1400 and maximize the navigation visualization interface 1310 (i.e., returning back to the full view) by swiping from right towards the left. For example, the operator's hand 1110 may begin swiping at the border between the interfaces 1400 and 1310 and end towards the left edge of the touch screen interface to minimize the trip visualization interface 1400. The digital interface generator 260 may receive gestures (e.g., swipe, pinch, tap) to add, remove, enlarge, shrink, or otherwise change the position or size of interfaces. This functionality provides enhanced convenience and safety features for the operator when a display size may be limited or small. Moreover, having many displays simultaneously on a single screen may be providing more information than is necessary to an operator and cause delays when an operator is trying to find a particular resource or information. These delays may add risks to flight safety. By enabling the operator to control the information displayed on a screen with simple gestures such as swipes, the digital interface generator 260 provides a convenient and safe user interface.

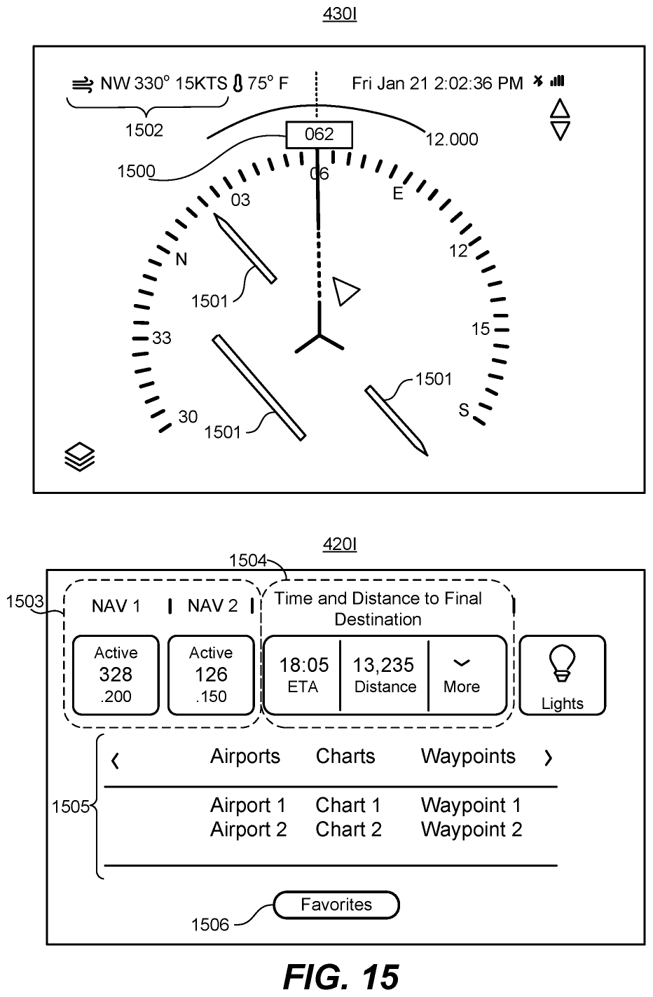

FIG. 15 shows the navigation visualization interface 430I displaying a flight navigation instrument and the aerial vehicle and trip configuration interface 420I displaying trip information, in accordance with one or more embodiments. The flight navigation instrument includes a heading indicator 1500, course division indicators 1501, and a wind indicator 1502, which may be generated by the digital interface generator 260. The course division indicators 1501 may be very high frequency omni-directional range (VOR) navigation indicators. An operator may use finger gestures, as described with reference to FIG. 11, to realign the course division indicators 1501 to navigate the aerial vehicle along a desired path. The digital interface generator 260 generates a NAV frequency dashboard 1503, a travel estimation dashboard 1504, a route selection menu 1505, and a favorite route button at the aerial vehicle and trip configuration interface 420I. The digital interface generator 260 may generate user input controls for changing a NAV frequency in response to an operator selecting a frequency at the NAV frequency dashboard 1503. The digital interface generator 260 may display additional travel information (e.g., modifying a display of a road map to show estimated times of arrival along various waypoints in a route) in response to receiving a user selection of the travel estimation dashboard 1504. The digital interface generator 260 may update the NAV frequency dashboard 1503 and the travel estimation dashboard 1504 with information corresponding to a new route in response to an operator selecting the new route from the route selection menu 1505. The universal vehicle control router 120 may maintain a data structure mapping routes to NAV frequencies used during each route, travel estimation information (e.g., estimated times of arrivals or estimated distances) for each route, any suitable information related to a route traveled, or a combination thereof. The vehicle control and interface system 100 may store the data structure in the data store 150.

In the example embodiment shown in FIG. 15, the routes of the route selection menu 1505 list airports as destinations. The route selection menu 1505 may also provide the operator with charts (e.g., aeronautical charts, airport diagrams, etc.). For example, in response to an operator selecting Chart 1 associated with Airport 1, the digital interface generator 260 may update the trip visualization interface 410 to display Chart 1. The vehicle control and interface system 100 may store the charts in the data store 150. The route selection menu 1505 can include a list of waypoints along a route to a corresponding airport. In response to an operator selecting a route from the route selection menu 1505 and in response, the digital interface generator 260 may display a prompt to the user to begin engine startup checks. For example, the digital interface generator 260 may generate a similar GUI as the GUI 400 of FIG. 4 showing a preview of the user's route on a road map and a navigational control window displaying engine measurements and input controls for automated engine startup. In response to receiving an operator selection of the favorites button 1506, the digital interface generator 260 may display a list of favorite routes that the operator has previously specified as a favorite (e.g., stored by the vehicle control and interface system 100 to a profile of the operator within the data store 150).

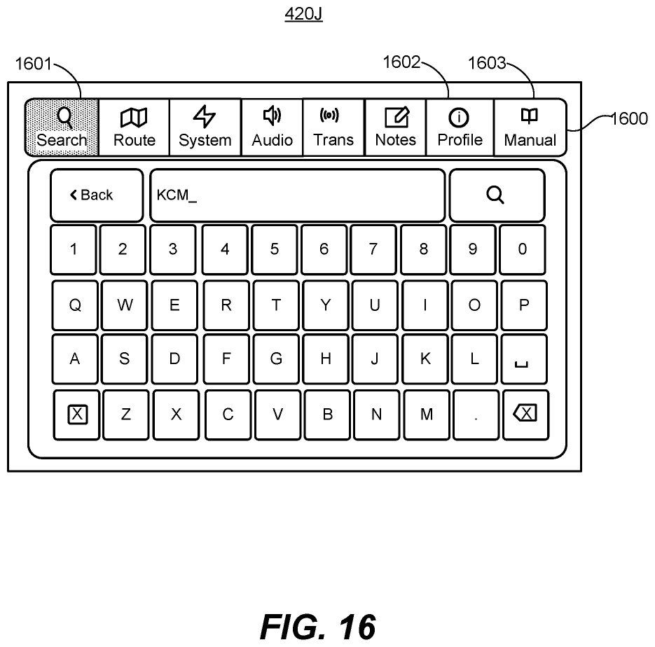

FIG. 16 shows the aerial vehicle and trip configuration interface 420J during a search for a travel destination, in accordance with one or more embodiments. The digital interface generator 260 can generate a virtual keyboard and receive an operator's selection of keys (e.g., via a touch screen or a mechanical controller stick) to specify a travel destination. As depicted in FIG. 16, an operator searching for Camarillo Airport, or KCMA, is providing the letters for the airport code to the vehicle control and interface system 100. In response to receiving the requested destination, the universal control router 120 may update the aerial vehicle and trip configuration interface 420 to display trip information (e.g., as shown in FIG. 15). The route control and settings menu 1600 is another embodiment of a menu that is different from the route control and settings menu 422 of FIG. 4.

The route control and settings menu 1600 includes a Search button 1601, a Profile button 1602, and a Manual button 1603. In response to receiving an operator's selection of the Search button 1601, the digital interface generator 260 displays user input controls configured to receive a user's query (e.g., for a destination, a keyword to search through a manual of the aerial vehicle, a keyword to search for assistance in operating the aerial vehicle, etc.). A flight control computer may determine results to return for the digital interface generator 260 to display or instruct the digital interface generator 260 to update the GUI to display an interface related to the query (e.g., displaying a route selection menu in response to receiving a query for a destination).

In response to receiving an operator's selection of the Profile button 1602, the digital interface generator 260 can display information stored in the operator's profile. The vehicle control and interface system 100 may maintain accounts for operators of the aerial vehicle, which may include identification credentials to access a secured account. In response to receiving an operator's selection of the Manual button 1603, the digital interface generator 260 can display a manual for operating the aerial vehicle.

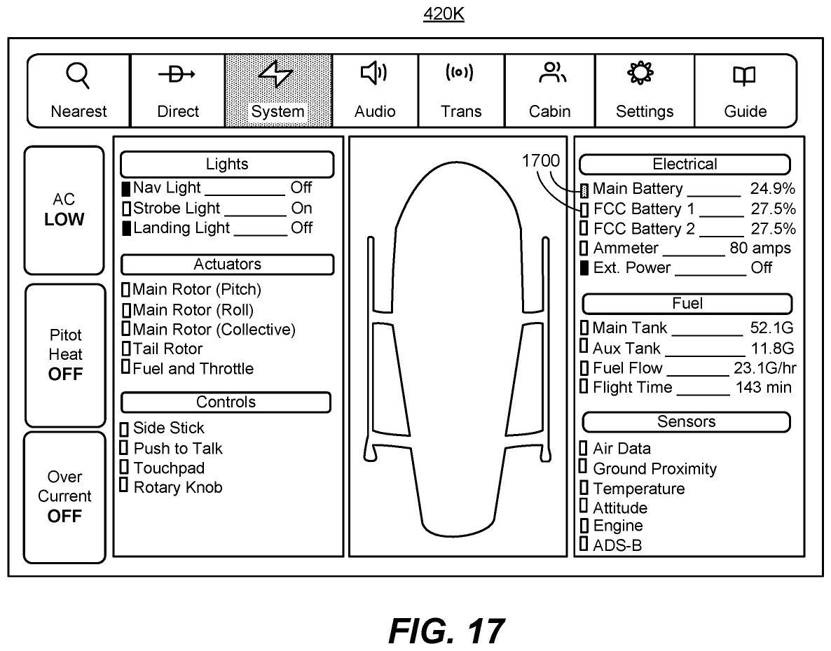

FIG. 17 shows aerial vehicle information displayed at the aerial vehicle and trip configuration interface 420K, in accordance with one or more embodiments. The aerial vehicle information may include the operation or health status of lights, actuators, and controls of the aerial vehicle. Status indicators 1500 are depicted as boxes next to corresponding components of the aerial vehicle. The universal vehicle control router 120 may determine a color-coded status for the digital interface generator 260 to display in each box. For example, the status of the Main Battery is displayed in a color indicating to the operator that the main battery may need inspection or attention.

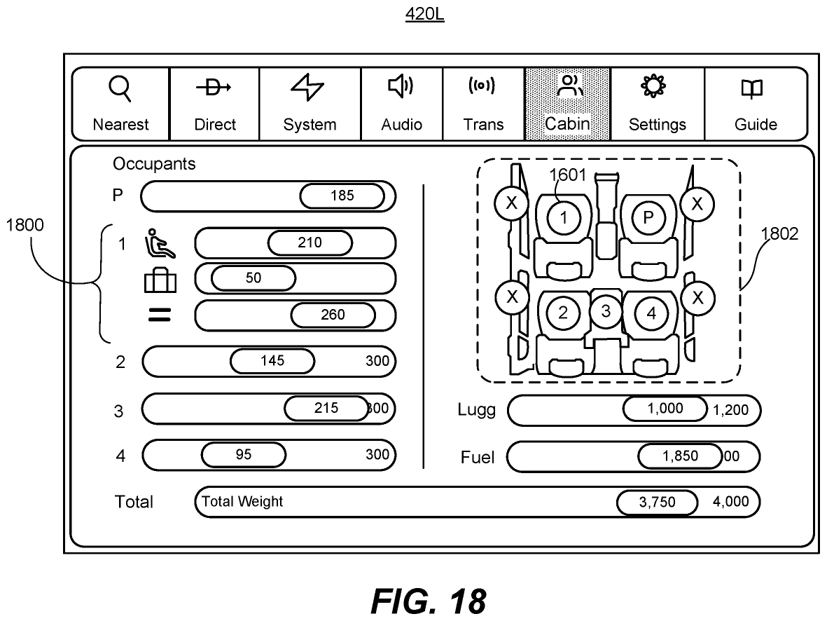

FIG. 18 shows cabin information displayed at the aerial vehicle and trip configuration interface 420L, in accordance with one or more embodiments. The cabin information may include visual sliders showing a current measurement relative to the minimum and maximum values that the aerial vehicle may be characterized by to operate safely. For example, the cabin information may reflect loads carried by the aerial vehicle (e.g., passenger, luggage, fuel, etc.). The aerial vehicle sensors may measure weights for each load, and the digital interface generator 260 may display the measured weights at the aerial vehicle and trip configuration interface 420L. For example, the weight information 1800 of a compartment 1801 (e.g., seating compartment), shown in the cabin diagram 1802, is presented as the passenger's weight (e.g., 210 pounds) in combination with the weight of the passenger's carry-on (e.g., 50 pounds). The digital interface generator 260 may display a notification or warning indicator (e.g., changing the color of the Total Weight slider to red) in response to a flight control computer of the universal vehicle control router 120 determining that the measured cabin information is not meeting one or more operation criteria (e.g., an amount of fuel is below a recommended minimum fuel amount).

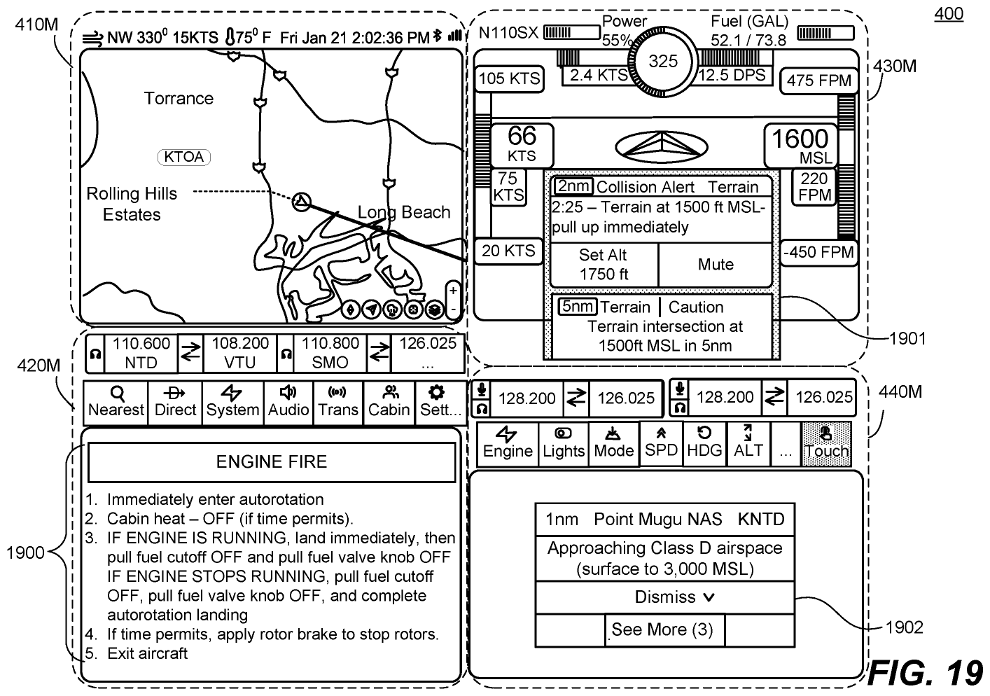

FIG. 19 shows the GUI 400 during an emergency landing, in accordance with one or more embodiments. The universal vehicle control router 120 may cause the digital interface generator 260 to display trip and aerial vehicle information, instructions, graphics, user input controls, or a combination thereof to assist the operator in making an emergency landing. The digital interface generator 260 may display a current location of the aerial vehicle at the trip visualization interface 410M, instructions to manage an emergency event (e.g., an engine fire) according to safety procedures at the aerial vehicle and trip configuration interface 420M, a flight display with recommended navigation instructions to avoid an obstacle (e.g., a collision with the ground) at the subjection 430M, and a navigation alert notification in the navigation configuration interface 440M.

The universal vehicle control router 120 may determine, using aerial vehicle sensors, that the aerial vehicle operation will soon be or is currently impacted by an emergency event that compromises the safety of the passengers aboard the aerial vehicle. Examples of emergency events include aerial vehicle malfunctions (e.g., engine failure, landing gear malfunction, loss of pressurization, etc.), natural disasters, fires on board the aerial vehicle, any suitable irregular event that develops within or outside of the aerial vehicle that impedes safe flight, or a combination thereof. In response to determining that an emergency event is occurring, the universal vehicle control router 120 may perform an automated recovery process to mitigate the effects of the emergency event on the safety of the passengers, modify user interfaces to instruct an operator how to mitigate the effects, or a combination thereof.

In the example embodiment shown in FIG. 19, an engine fire at the aerial vehicle has been detected by the universal vehicle control router 120 and the universal vehicle control router 120 provide information and guidance to the operator to perform a safe landing. The digital interface generator 260 displays instructions 1900 with a series of emergency management operations. An emergency management operation may be an operation performed during an emergency event to recover from the emergency event or reduce the impact of the emergency event. For example, in the event of an engine fire for a helicopter, the operator of the aerial vehicle is instructed to enter autorotation, shut off cabin heat, switch off fuel cutoff and fuel valve knobs, and after landing, apply a rotor brake and exit the aerial vehicle. The digital interface generator 260 displays recommended navigation instructions 1901 to guide the operator's navigation during an emergency event. The recommended navigation instructions 1901 include an instruction for the user to raise the aerial vehicle's altitude to avoid a collision with the ground in five nautical miles at a current rate of descent. A flight control computer of the universal vehicle control router 120 may determine recommended navigation instructions for the digital interface generator 260 to display. The recommended navigation instructions 1901 includes a user control input that enables the operator to select to cause a flight control computer to instruct an actuator to follow a navigational setting (e.g., a requested altitude of 1750 feet). The digital interface generator 260 may display a navigation alert notification that can include information related to air traffic, waypoints, destinations, navigational settings, COM frequencies, or any suitable information about the aerial vehicle's navigation. The navigational alert notification 1902 includes air traffic information indicating to the operator that the aerial vehicle is approaching a controlled airspace (e.g., a Class D airspace) and recommends to the operator to increase the altitude of the aerial vehicle to 3,000 MSL to avoid the controlled airspace.

The universal vehicle control router 120 may determine GUI elements for presenting to the operator in a manner that is appropriate for digestion during a high tension, emergency event (e.g., when the operator does not have time to look through a manual). The digital interface generator 260 may automatically generate or update user inputs or information displayed in response to the universal vehicle control router 120 determining that an emergency management operation has been completed. In one example, the universal vehicle control router 120 determines that an emergency management operation to be performed during the emergency event of an engine fire is to turn off cabin heat. The universal vehicle control router 120 may display instructions (e.g., using the aerial vehicle and trip configuration interface 420M) to an operator to perform this operation or may automatically reduce cabin heat (e.g., turning off heating elements within the cabin). The universal vehicle control router 120 determines, using an aerial vehicle sensor, that the cabin heat is turned off and in response, the universal vehicle control router 120 may switch a fuel valve off or display instructions for the operator to switch off the fuel valve. Although instructions for emergency management operations are depicted in FIG. 19 as being displayed at one instance, the universal vehicle control router 120 may display a subset of the instructions in a sequence as needed (e.g., one instruction at a time as the operator or the universal vehicle control router 120 performs the instruction). In this way, the universal vehicle control router 120 accounts for the space on an electronic display and the context of an emergency event, where an operator is likely to comprehend a moderated amount of information provided to them over time.

FIG. 20 is a flowchart of a process 2000 for generating and updating a GUI for controlling aerial vehicle navigation using finger gestures, in accordance with one or more embodiments. The process 2000 may be performed by the vehicle control and interface system 100. The process 2000 may have additional, fewer, or different operations.

The vehicle control and interface system 100 generates 2010 a GUI for display that includes an avatar of the aerial vehicle and one or more aerial vehicle attitude indicators. Additionally, the vehicle control and interface system 100 may generate a representation of an environment in which the aerial vehicle travels. FIG. 11 depicts examples of an avatar 432 of the aerial vehicle and aerial vehicle attitude indicators 1108 and 1109, which can be generated by the digital interface generator 260. The vehicle control and interface system 100 receives 2020 a user interaction via the GUI displayed that corresponds to an instruction to modify a navigation of the aerial vehicle, where the user interaction includes a gesture of one or more fingers against a touch screen interface through which the aerial vehicle is controlled. For example, the universal vehicle control router 120 can receive an operator's gesture of one finger swiping leftward at the navigation configuration interface 440G to command the aerial vehicle to change its lateral orientation. The vehicle control and interface system 100 determines 2030 a modification of the one or more aerial vehicle attitude indicators based on the instruction. The universal vehicle control router 120 may modify the aerial vehicle attitude indicator 1109 to rotate in a number of degrees proportional to a characteristic of the finger gesture (e.g., an acceleration of the swipe, a distance of the swipe, etc.).

### Example Movable Control Interface of the Vehicle Control and Interface System

Referring now to FIGS. 21-28, various example configurations of a movable control interface of an aerial vehicle are described. The movable control interface may be a component of the universal vehicle control interfaces 110. The GUIs described with reference to FIGS. 4-6 and 8-19 may be displayed at an electronic display (e.g., a touch screen interface) of the movable control interface. FIGS. 21-27 are presented in a sequence showing a touch screen interface of the movable control interface as it is extended from a stowed position to an in-flight (e.g., as an operator is preparing for flight). Although the GUIs displayed at the touch screen interfaces shown in FIGS. 21-27 side-by-side, the GUIs may be displayed in alternative configurations, for example, as vertically stacked, as cards (e.g., may be swiped left or right on the screen), or as a carousel.

FIG. 21 shows a front view of a stowed position of a touch screen interface 2100 of a movable control interface 2105, in accordance with one or more embodiments. The movable control interface 2105 may be located in the cockpit of an aerial vehicle. An operator of an aerial vehicle may control the aerial vehicle using the touch screen interface. The operator may be seated in a pilot seat 2103 of the cockpit. One or more of the pilot seat 2103 or a co-pilot seat 2104 may be coupled to an arm rest console. The arm rest console may include an arm rest 2102 and a mechanical controller stick 2101 that enables an operator of the aerial vehicle to control navigation of the aerial vehicle. The arm rest console may be adjacent to the pilot seat 2103. The arm rest may have a front portion that is proximal to a mechanical controller stick. For example, the mechanical controller stick can be located between the front portion of the arm rest and the touch screen interface 2100. This configuration may also be described as the mechanical controller stick being across from the touch screen and in front of the front portion of the arm. The mechanical controller stick is structured for movement to enable an operator to control navigation of an aerial vehicle.

By placing the touch screen interface 2100 a stowed position, the movable control interface 2105 enables greater degrees of movement for a pilot and/or co-pilot within the cockpit. As depicted, the touch screen interface 2100 is located at the front and center of the cockpit when in a stowed position, in between a pilot seat 2103 and a co-pilot seat 2104. In alternative embodiments, the touch screen interface 2100 in a stowed position may be located ahead of either the pilot seat 2103 or the co-pilot seat 2104. The touch screen interface 2100 may be positioned in a stowed position when a mechanical arm and the components thereof (extendable segments of the arm, hinges, etc.) are in retracted positions, causing the touch screen interface 2100 to be positioned away from the pilot or co-pilot.

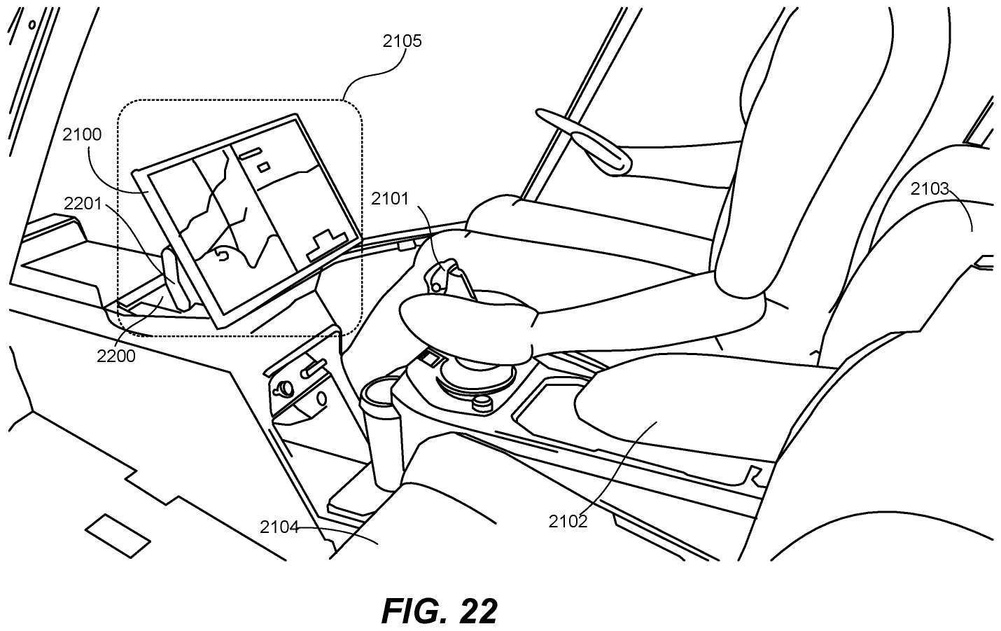

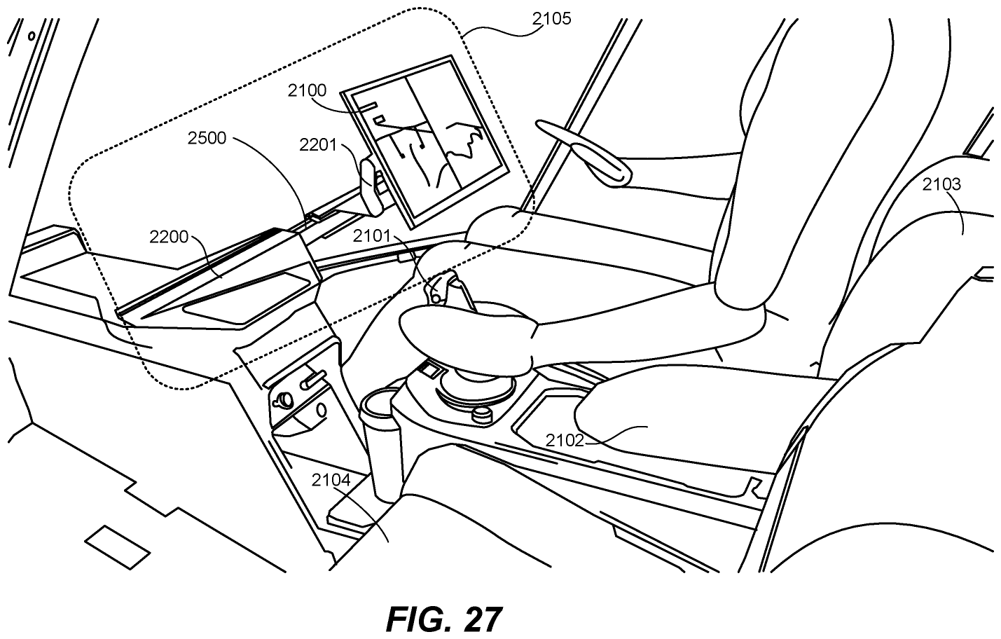

A mechanical arm coupled to the touch screen interface 2100 may enable the touch screen interface 2100 to move into various positions (e.g., a stowed position ahead of the pilot seat 2103 or the co-pilot seat 2104). Example positions include a stowed position, an in-flight position, or various intermediate positions reachable by the mechanical arm while moving the touch screen interface 2100 between the stowed and in-flight positions. The touch screen interface 2100 may be located farther from the pilot seat 2103 in the stowed position than in the in-flight position. In the in-flight position, the touch screen interface 2100 can be positioned, using the mechanical arm, to be in front of the pilot seat 2103 at an elevation relative to the pilot seat 2103 such that a top portion of the touch screen interface (e.g., the top edge of the rectangular touch screen interface 2100) is at least a threshold distance below a headrest of the pilot seat 2103. An example of the touch screen interface 2100 in the in-flight position is depicted in FIG. 27. In some embodiments, the mechanical arm may enable the touch screen interface 2100 to move into a stowed position that is in front of the pilot seat 2103. The touch screen interface 2100 may be angled towards the pilot seat 2103 or the co-pilot seat 2104. Although not depicted from the forward facing perspective shown in FIG. 21, the mechanical arm is described in greater detail with reference to FIGS. 22-27.

FIG. 22 shows an isometric view of a movable control interface 2105 having a touch screen interface 2100 that is raised from a stowed position, in accordance with one or more embodiments. The touch screen interface 2100 is coupled to a mechanical arm 2200 of the movable control interface 2105. The mechanical arm 2200 may be attached to a dashboard in the cockpit of the aerial vehicle. The mechanical arm 2200 may include one or more segments that move the touch screen interface to various positions, including the position depicted in FIG. 22 that is raised from a stowed position. In some embodiments, the movement of the mechanical arm 2200 may be enabled by one or more segments that releasably hold the touch screen to one of many positions. These positions may be referred to as “fixable positions.” For example, one segment may extend from another segment using one or more sliding tracks that include latching mechanisms (e.g., spring-loaded pins that engage with holes along the tracks). These latching mechanisms can hold the extended segment at one position until an operator applies force to the latching mechanism to release the extended segment from the latching mechanism's hold. In another example, the segments can include one or more hinges 2201 that may automatically (e.g., motor powered) or manually moved to move the touch screen interface 2100 up or down. The movement can hold the segments in place until the user engages to release the segments from such a hold (i.e., releasably holding the touch screen interface). The mechanical arm 2200 may include extendable segments that affords the touch screen interface 2100 additional degrees of movement (e.g., extending from the center dashboard to being in front of the pilot seat 2103).

In some embodiments, the vehicle actuators 130 may include an electric motor of the mechanical arm 2200 that may operate in response to receiving instructions from the universal vehicle control router 120. The universal vehicle control router 120 may determine to automatically move the mechanical arm 2200 in response to an operator presence state. For example, the universal control router 120 may receive sensor data from the vehicle sensors 140 indicating that an operator has seated themselves in the pilot seat 2103 (e.g., using a weight sensor, heat sensor, camera, etc.), determine that the operator presence state is “present,” and in response, cause an electric motor of the mechanical arm 2200 to move the touch screen interface 2100 from a stowed position to an in-flight position. In another example, the universal control router 120 may determine that the aerial vehicle is undergoing an emergency event and recommends immediate evacuation from the aerial vehicle and in response, cause an electric motor of the mechanical arm 2200 to move the touch screen interface 2100 from an in-flight position to a stowed position. Thus, in response to an emergency evacuation of the aerial vehicle, the mechanical arm 2200 may be configured to move the touch screen interface 2100 to a stowed position. In some embodiments, the universal control router 120 may maintain, using a locking mechanism, the touch screen interface 2100 in a stowed position until the universal control router 120 determines that one or more operation criteria are met. For example, the universal control router 120 may use an operation criterion that seat belts must be engaged before the touch screen interface 2100 may be moved from the stowed position. In some embodiments, the digital interface generator 260 may display a button for user selection to instruct the universal control router 120 to move the touch screen interface 2100 into a particular position (e.g., into the in-flight position). The universal control router 120 may record previously used positions of the touch screen interface 2100 used by operators (e.g., stored as a favorite in-flight position settings in a user profile) and the digital interface generator 260 may display the previously used positions for operator selection. These stored, previous user positions may be referred to as operator position preferences or pilot position preferences. In some embodiments, the universal control router 120 may automatically determine to move the touch screen interface 2100 to one of an operator's position preferences in response to determining the identity of the operator as they initially settle into the aerial vehicle (e.g., after providing login credentials to access an account with the vehicle control and interface system 100).

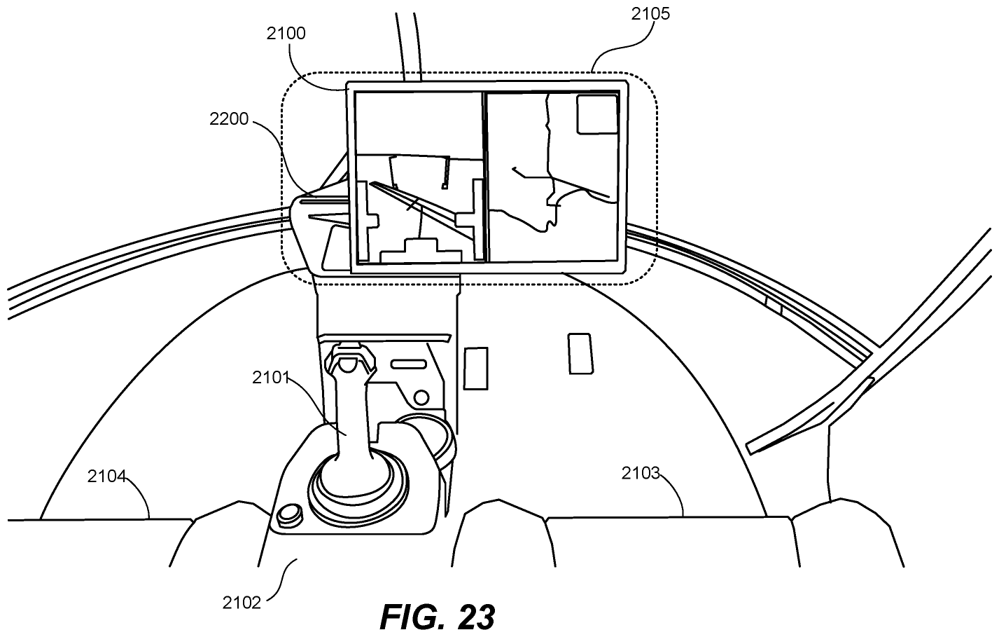

FIG. 23 shows a front view of a movable control interface 2105 having a touch screen interface 2100 that is raised and extended from a stowed position, in accordance with one or more embodiments. The extension of the mechanical arm 2200 depicted in FIG. 23 may be evident when compared to the front view of FIG. 21, where the mechanical arm 2200 has not yet extended the touch screen interface 2100 horizontally towards the pilot seat 2103. The mechanical arm 2200 may include one or more segments that may extend the touch screen interface 2100 towards the pilot seat 2103 and/or the co-pilot seat 2104. The one or more segments may include discrete, interlocking segments. In some embodiments, the one or more segments may include coaxial segments with varying radii, where a coaxial segment is configured to slide along a different coaxial segment to extend the mechanical arm 2200 inward and outward. The one or more segments of the mechanical arm 2200 may extend in a straight line, as depicted in the sequence of positions taken by the touch screen interface 2100 in FIGS. 23-26 as the mechanical arm 2200 extends towards the pilot seat 2103.

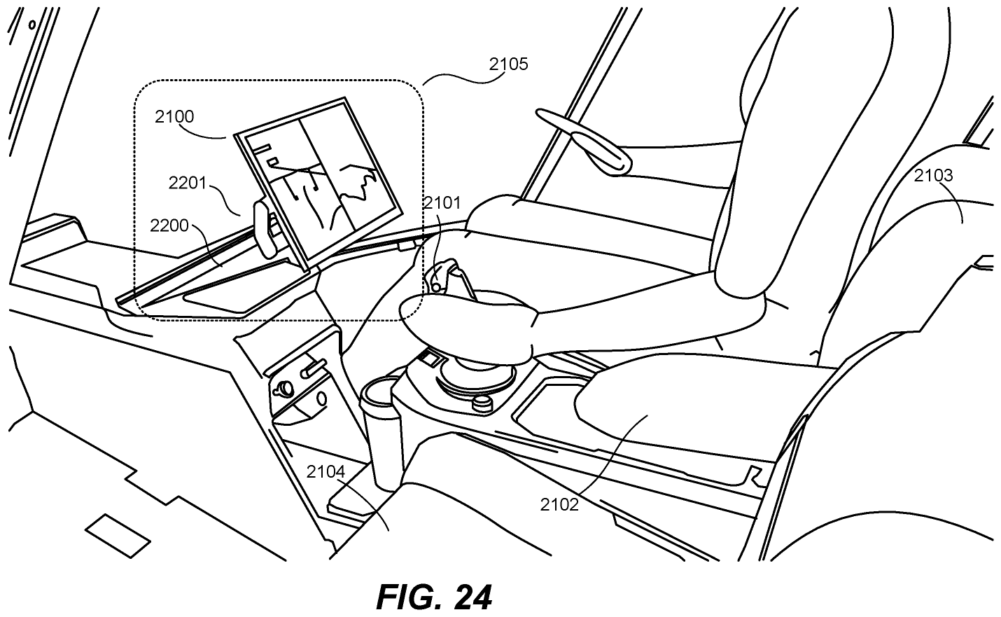

FIG. 24 shows an isometric view of a movable control interface 2105 having a touch screen interface 2100 that is raised and extended from a stowed position, in accordance with one or more embodiments. FIG. 24 depicts an isometric view of an intermediary position for which a front view is depicted in FIG. 23. The extension of the mechanical arm 2200 depicted in FIG. 24 may be evident when compared to the isometric view of FIG. 22, where the mechanical arm 2200 has not yet extended the touch screen interface 2100 horizontally towards the pilot seat 2103.

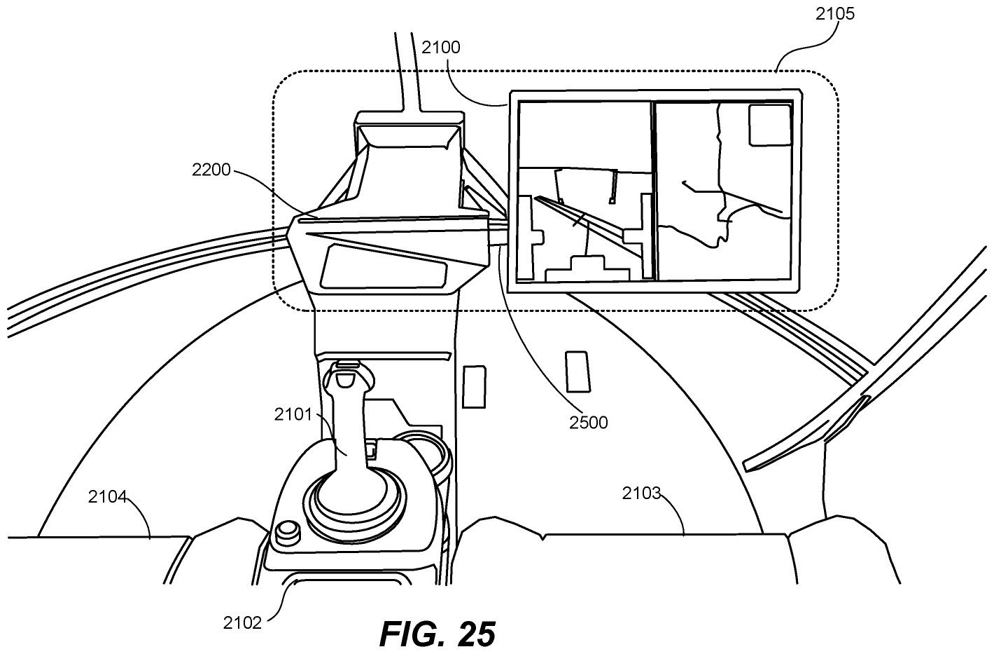

FIG. 25 shows a front view of a movable control interface 2105 having a touch screen interface 900 that is raised and extended, in accordance with one or more embodiments. The intermediary position depicted in FIG. 25 during the transition from the stowed to in-flight positions of the touch screen interface 2100 is achieved by the mechanical arm 2200 that is extended towards the pilot seat 2103 further than depicted in FIGS. 23-24. A first segment of the mechanical arm 2200 may be immovable from the dashboard segment and may house one or more smaller segments (e.g., a segment 2500) extendable from one another towards the pilot seat 2103 or the co-pilot seat 2104. The extending segments may be retractable, interlocking segments (e.g., using ball locks or any other suitable mechanism for locking extending segments).

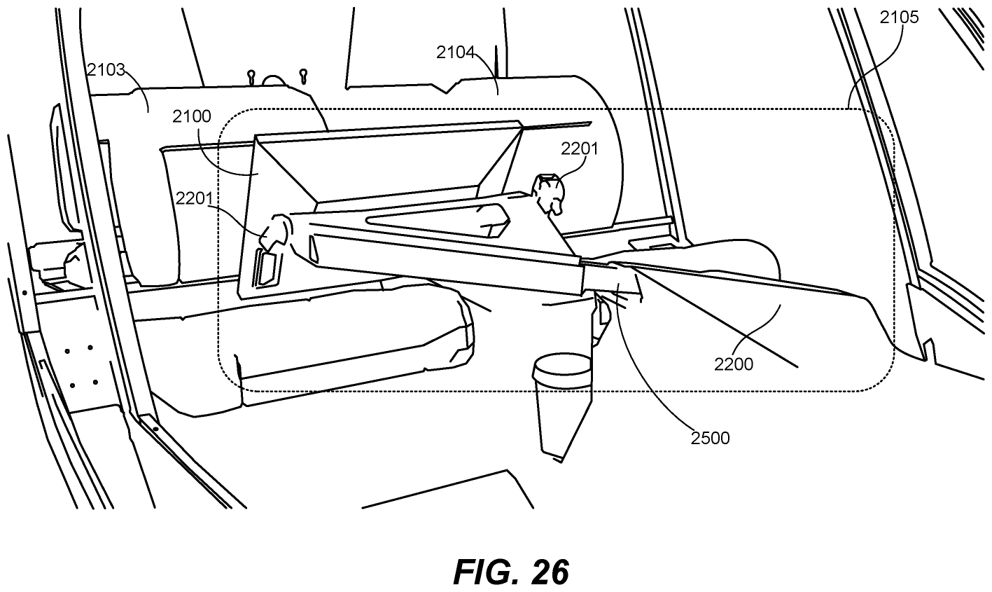

FIG. 26 shows a rear view of a movable control interface 2105 having a touch screen interface 900 that is extended into an intermediary position, in accordance with one or more embodiments. The rear view additionally shows two hinges 2201 that enable the touch screen interface 2100 to move vertically and/or rotate axially about a connection on the hinges 2201. As depicted in FIG. 26, the hinges 2201 are lowered. The difference between raised and lowered hinges may be evident when comparing the lowered configuration in FIG. 26 to the raised configurations in FIGS. 22, 24, and 27. The movement of the touch screen interface 2100 by the mechanical arm 2200 may optionally include lowering the hinges 2201 as depicted in FIG. 26. However, the touch screen interface 2100 may optionally stay raised (i.e., not lowered) during the move from a stowed position to an in-flight position.

FIG. 27 shows an isometric view of a movable control interface 2105 having a touch screen interface 2100 that is in an in-flight position, in accordance with one or more embodiments. In the in-flight position, the touch screen interface 2100 is raised (e.g., by the hinge(s) 2201) and extended horizontally (e.g., towards the pilot seat 2103) by extending segments (e.g., the segment 2500) of the mechanical arm 2200. The in-flight position of the touch screen interface 2100 is in front of the pilot seat 2103 at an elevation relative to the pilot seat such that a top portion of the touch screen interface 2100 is at least a threshold distance below a headrest of the pilot seat 2103. In the event the pilot seat 2103 lacks a headrest, the in-flight position of the touch screen interface 2100 may be located such that the top of the touch screen interface is at least a first threshold distance below the top of the seat or at most a second threshold distance above the top of a mechanical controller stick. For example, the touch screen interface 2100 may be at least 30 centimeters below a headrest of the pilot seat 2103 (e.g., and at most 100 centimeters below the headrest) or at most 75 centimeters above the top of the mechanical controller stick 2101. This minimal distance below the headrest may enable the operator to see an environment outside the aerial vehicle with reduced obstruction from the touch screen interface 2100 while also being accessible to the operator's hand without lifting their elbow or shoulder to reach the touch screen interface 2100 above where their hand may comfortably fall. Thus, the movable control interface 2105 provides for stable usage of the touch screen interface 2100 during flight (e.g., when the touch screen interface 2100 is in an in-flight position). Furthermore, the minimal distance below the headrest may also enable the touch screen interface 2100 to be located low and close relative to a torso of an operator, which in turn prevents impact between the touch screen interface 2100 and the head of the operator in the event of a crash. This is in contrast to the dashboard of a conventional plane, which is relatively at level with a torso of an operator and thus, may come into contact with the operator's head in the event of a crash where the body of the operator is propelled towards the dashboard through forces of the crash (e.g., the operator's head lowers during impact and hits the dashboard as their waist or torso is held in contact with their chair). The touch screen interface 2100 in the in-flight position may be located such that it is reachable by an operator ergonomically (e.g., without straining their shoulder or arm when reaching for the touch screen interface 2100). For example, the touch screen interface 2100 may be a range of 60-90 centimeters in front of the pilot seat 2103.

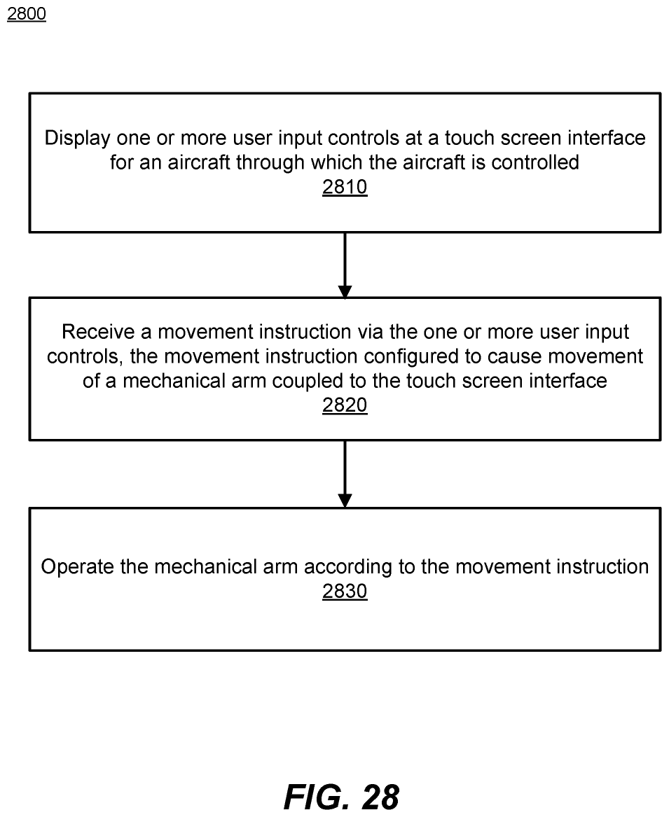

FIG. 28 is a flowchart of a process 2800 for operating a movable control interface of the vehicle control and interface system 100, in accordance with one embodiment. The process 2800 may be performed by the vehicle control and interface system 100. The process 2800 may have additional, fewer, or different operations.

The vehicle control and interface system 100 displays 2810 one or more user input controls at a touch screen interface (e.g., the touch screen interface 2100) for an aerial vehicle, where an operator can control the aerial vehicle through the touch screen interface. For example, the digital interface generator 260 may generate for display any one of the interfaces depicted in FIGS. 4-6 and 8-19. The generated interfaces may include user input controls for controlling movement of the touch screen interface. The vehicle control and interface system 100 receives 2820 a movement instruction via the one or more user input controls. The movement instruction is configured to cause movement of a mechanical arm (e.g., the mechanical arm 2200) coupled to the touch screen interface. For example, an operator selects a button for moving the touch screen interface to a particular position (e.g., stowed or in-flight positions) or in requested directions and/or increments (e.g., the digital interface generator 260 generates arrow keys that, upon selection by an operator, cause the movement of the mechanical arm 2200 in a direction corresponding to the selected arrow key). The vehicle control and interface system 100 operates 2830 the mechanical arm according to the movement instruction. For example, the universal vehicle control router 120 causes a vehicle actuator (e.g., an electric motor controlling movement of the mechanical arm 2200) to move the mechanical arm 2200 in a direction or position specified by the movement instruction.

### Example Gesture-Based Vehicle Control

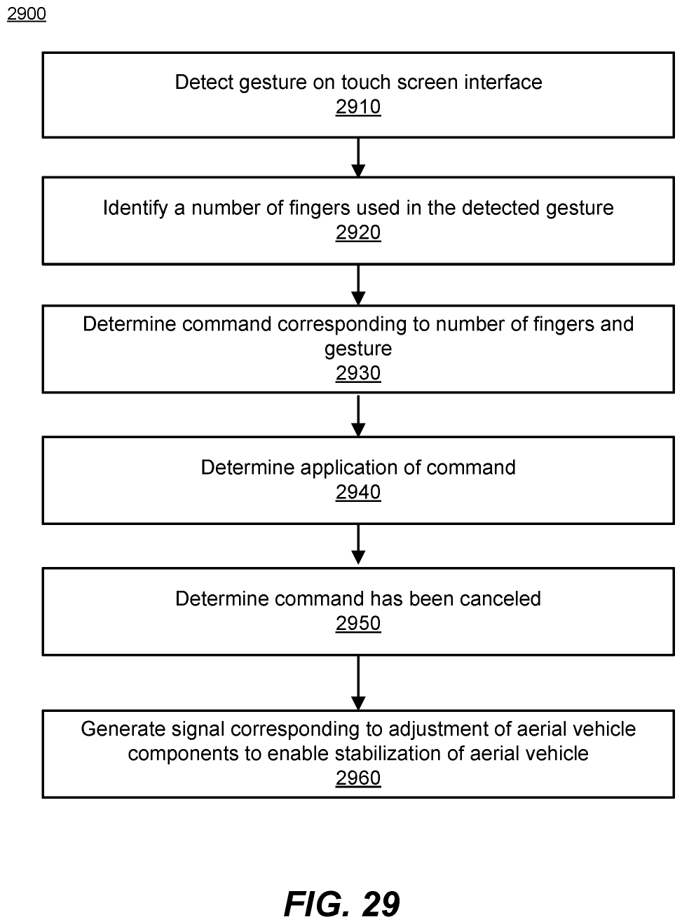

FIG. 29 is a flowchart of a process for controlling an aerial vehicle based on user gestures, in accordance with at least one embodiment. The aerial vehicle may be either a rotary wing aircraft (e.g., a helicopter) or a fixed wing aircraft (e.g., an airplane). The process 2900 may be performed by the vehicle control and interface system 100. The process 2900 may have additional, fewer, or different operations. Additional examples of controlling an aerial vehicle based on user gestures is described with respect to FIG. 11.

The vehicle control and interface system 100 detects 2910 a gesture, e.g., through an interaction with a displayed GUI, on a touch screen interface. The gesture may be an applied force of one or more fingers in contact with a touch screen interface of the aerial vehicle. Gestures can include a swipe, a press, a tap, a hold, a rotation, any suitable motion or application of force against the touch screen, or a combination thereof.

The vehicle control and interface system 100 identifies 2910 a number of fingers used in the detected gesture. One gesture may correspond to different commands depending on the number of fingers used. For example, a tap gesture using one finger may cause the aerial vehicle to increase or decrease a parameter of operation (e.g., speed) by one unit of measurement while a tap gesture using two fingers may cause the aerial vehicle to increase or decrease the operation parameter by two units of measurement.

The vehicle control and interface system 100 determines 2930 a command corresponding to the number of fingers detected and the detected gesture. Example commands including changing speed, moving the lateral or vertical axis of the vehicle, changing heading, engage in a turn (e.g., a banked turn), changing altitude, any suitable command affecting the vehicle's motion, or a combination thereof.

The vehicle control and interface system 100 determines 2940 an application of the determined command. Example applications of the command can include navigation, takeoff, landing, and any suitable process related to operating the vehicle.

The vehicle control and interface system 100 determines 2950 that the command has been canceled. For example, a double tap to cancel command receives a rapid double tap (e.g., very short time sequence consecutive taps) that corresponds to the command sought to be canceled. For example, if the pilot of the aerial vehicle sought to cancel the banked turn, the pilot would perform a rapid double tap with two fingers on the touch pad. A signal corresponding to this action that included detection of the two fingers is transmitted to the system 100. The two-finger double tap confirmed as mapped to a banked turn and the system identifies within the stored log that the last banked turn was to the left. In some embodiments, the system 100 can determine 2950 that the command has been canceled prior to determining 2940 the application. The determination of an application may also be omitted from the process 2900.

The vehicle control and interface system 100 generates 2960 a signal corresponding to an adjustment of aerial vehicle components to enable stabilization of the aerial vehicle. Following the prior example, to cancel the turn to the left and update the heading for the aircraft to the now new the travel path vector, the system 100 transmits signals to the corresponding aircraft actuators to update the heading for the aircraft.

As has been noted the system as configured includes a number of benefits and advantages to simplify operation of vehicles such as aircraft by taking advantage of a simplified cockpit environment that includes a touch pad and controller as described. For example, in some embodiments the system may preprogram certain gestures and/or rapid interactions, e.g., tap or taps on touchpad, to correspond to specific commands. The gestures and/or rapid interactions on the touch pad are translated as signals for the processor system to process with the flight operating system. The flight operating system further translates the received commands to have the aircraft components, e.g., actuators, to perform specific actions corresponding to what the pilot intended with the gesture and/or rapid interaction. The gestures and/or rapid interactions may include permutations that take into account the number of fingers of a pilot that are applied to the touch pad. For example, two finger rapid tap with a single finger swipe may be one command, a three finger rapid tap with a two finger swipe may be a second command, and a two finger rapid tap with a two finger swipe may be a third command. Hence, the number of potential commands enabled may can be significantly increased based number fingers (including thumb) applied as well as combination applied (e.g., just gesture or rapid interaction or both together).

By way of example, a rapid double tap with two fingers followed by a two finger gesture from right to left on the touch pad may correspond to the two finger rapid tap triggering a banked turn command followed by the two finger swipe direction corresponding to the turn direction, e.g., here to the left. This signal is transmitted back to the flight operation system that, in turn, signals the aircraft components to configure to engage a banked turn to the left. Further by example, three finger rapid tap may followed by a two finger swipe from bottom to top of touch pad (e.g., up direction) may correspond to the three finger rapid tap triggering a command to change altitude and the two finger swipe up direction corresponding to an increase of altitude. The flight operating system stores in memory a running list of commands as they are entered by a pilot. The memory may be configured to store in a log a predetermined set of recent command, e.g., 25 most recent, or may be configured to store all commands until the flight is completed. Further, the commands received may further be stored, e.g., in a database log, in longer term storage.

In some example embodiments, rapid cancellation of a command may be desired as noted previously. Often, there is no mechanism to cancel previously provided commands, but rather new actions must be taken to override prior commands. The disclosed configuration allows for rapid cancellation of a command through a double tap action on the touch pad. In one example embodiment, a double tap to cancel command receives a rapid double table (e.g., very short time sequence consecutive taps) that corresponds to the command sought to be canceled. Using the prior example, if the pilot sought to cancel the banked turn, the pilot would perform a rapid double tap with two fingers on the touch pad. A signal corresponding to this action that included detection of the two fingers is transmitted to the processing system and flight operating system. The two finger double tap confirmed as mapped to a banked turn and the system identifies within the stored log that the last banked turn was to the left. To cancel the turn to the left and update the heading for the aircraft to the now new the travel path vector, the flight operating system transmits signals to the corresponding aircraft actuators to update the heading for the aircraft. Also using the prior example, if the action to be canceled was the altitude change of the aircraft, the pilot performs a rapid double tap on the touchpad with three fingers. The rapid double tap and three fingers are detected and a signal corresponding to what was detected on the touch pad are sent back to the processing system and flight operation system. The flight operating system determines that the three fingers detected corresponds to altitude change and that the log action was for a rise in altitude. The flight operating system generates a signal for the actuators that adjusts the actuators so that the aircraft no longer is climbing and is leveling out on its flight vector.

### Computing Machine Architecture

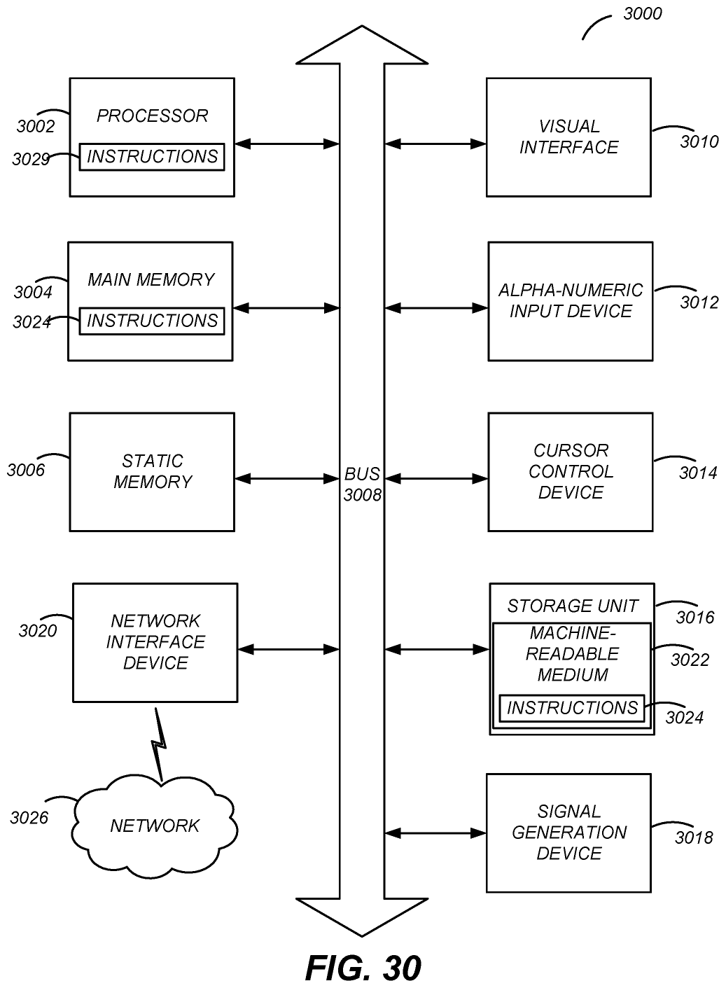

FIG. 30 is a block diagram illustrating one embodiment of components of an example machine able to read instructions from a machine-readable medium and execute them in a processor (or controller). Specifically, FIG. 30 shows a diagrammatic representation of a machine in the example form of a computer system 3000 within which program code (e.g., software) for causing the machine to perform any one or more of the methodologies discussed herein may be executed. The computer system 3000 may be used for one or more components of the vehicle control and interface system 100 depicted and described throughout the specification with FIGS. 1-29. The program code may be comprised of instructions 3024 executable by one or more processors 3002. In alternative embodiments, the machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The machine may be a computing system capable of executing instructions 3024 (sequential or otherwise) that specify actions to be taken by that machine. Further, while only a single machine is illustrated, the term “machine” shall also be taken to include any collection of machines that individually or jointly execute instructions 3024 to perform any one or more of the methodologies discussed herein.

The example computer system 3000 includes one or more processors 3002 (e.g., a central processing unit (CPU), a graphics processing unit (GPU), a digital signal processor (DSP), one or more application specific integrated circuits (ASICs), one or more radio-frequency integrated circuits (RFICs), field programmable gate arrays (FPGAs)), a main memory 3004, and a static memory 3006, which are configured to communicate with each other via a bus 3008. The computer system 3000 may further include visual display interface 3010. The visual interface may include a software driver that enables (or provide) user interfaces to render on a screen either directly or indirectly. The visual interface 3010 may interface with a touch enabled screen. The computer system 3000 may also include input devices 3012 (e.g., a keyboard a mouse), a storage unit 3016, a signal generation device 3018 (e.g., a microphone and/or speaker), and a network interface device 3020, which also are configured to communicate via the bus 3008.

The storage unit 3016 includes a machine-readable medium 3022 (e.g., magnetic disk or solid-state memory) on which is stored instructions 3024 (e.g., software) embodying any one or more of the methodologies or functions described herein. The instructions 3024 (e.g., software) may also reside, completely or at least partially, within the main memory 3004 or within the processor 3002 (e.g., within a processor's cache memory) during execution.

### ADDITIONAL CONFIGURATION CONSIDERATIONS

The disclosed systems may increase vehicle safety by providing a full fly-by-wire (FBW) architecture with a redundant architecture. For example, the FBW architecture may comprise triple redundancy, quadruple redundancy, or any other suitable level of redundancy. The systems may enable retrofitting an existing vehicle with an autonomous agent (and/or enable autonomous agent certification) by providing a sufficient degree of control and power redundancy to autonomous agents.

The disclosed systems may enable autonomous and/or augmented control schemes without relying on the pilot (or other operator) as a backup in the event of power failure. Accordingly, such systems may fully eliminate the ‘direct human control’ layer because augmented modes are persistent in the event of multiple power failures (e.g., augmented control modes can rely on triply-redundant, continuous backup power). Such systems may allow transportation providers and users to train in only a normal mode, thereby decreasing or eliminating training for ‘direct’ or ‘manual’ modes (where they are the backup: and relied upon to provide mechanical actuation inputs). Such systems may further reduce the cognitive load on pilots in safety-critical and/or stressful situations, since they can rely on persistent augmentation during all periods of operation. The systems are designed with sufficient redundancy that the vehicle may be operated in normal mode at all times. In contrast, conventional systems generally force operators to train in multiple backup modes of controlling an aerial vehicle.

The disclosed systems may reduce vehicle mass and/or cost (e.g., especially when compared to equivalently redundant systems). By co-locating multiple flight critical components within a single housing, systems can reduce the cable length, minimize the number of distinct connections required for vehicle integration (thereby improving ease of assembly), and allow use of less expensive sensors and/or processors without an electronics bay (e.g., as individual components can often require unique electrical and/or environmental protections).

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium and processor executable) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module is a tangible component that may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Upon reading this disclosure, those of skill in the art will appreciate still additional alternative structural and functional designs for a system and a process for vehicle control (e.g., startup, navigation and guidance and shutdown) through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A non-transitory computer-readable storage medium comprising stored instructions, the instructions when executed by a processor of an aerial vehicle control and interface system cause the aerial vehicle control and interface system to:
generate a graphical user interface (GUI) comprising a plurality of aerial vehicle monitor graphics providing an operator of an aerial vehicle with status information related to operations of the aerial vehicle;
measure a plurality of pre-start engine parameters using one or more of a plurality of sensors coupled to the aerial vehicle;
generate a first status indicator for display at the GUI indicating that an engine of the aerial vehicle is ready to be started if determined that a first plurality of operational criteria are satisfied by the plurality of pre-start engine parameters;
when the engine of the aerial vehicle is started, for each computer of a plurality of computers, further instructions to:
measure a post-start engine parameter using a sensor of the plurality of sensors coupled to the aerial vehicle;
verify that the measured post-start engine parameters satisfy one or more accuracy criteria; and
modify one or more of the plurality of aerial vehicle monitor graphics of the GUI to reflect the verified post-start engine parameters; and
generate a second status indicator for display at the GUI indicating the aerial vehicle is ready for flight if determined that a second plurality of operational criteria are satisfied by the verified post-start engine parameters.

2. The non-transitory computer-readable storage medium of claim 1, wherein each of the plurality of computers is associated with respective channels for providing instructions to actuators of the aerial vehicle, wherein the actuators are coupled with the engine, and wherein the instructions when executed further cause the aerial vehicle control and interface system to:
generate actuator instructions for the actuators in the respective channels; and
determine, using a voter in each channel, a validity of an actuator instruction provided to the engine.

3. The non-transitory computer-readable storage medium of claim 1, wherein the one or more accuracy criteria comprise a range of values for a particular post-start engine parameter, the range determined using a machine learning model trained using historical post-start engine parameters indicating that a historical aerial vehicle was ready for flight.

4. The non-transitory computer-readable storage medium of claim 1, wherein a safety criterion of the second plurality of operational criteria includes a temperature of engine oil being within a predetermined range for a predetermined duration of time.

5. The non-transitory computer-readable storage medium of claim 1, wherein the measured post-start engine parameters include an oil pressure and an oil temperature, wherein an operational criterion of the second plurality of operational criteria includes:
the oil pressure meeting a target oil pressure within a first predetermined duration of time since starting the engine of the aerial vehicle, and
the oil temperature is maintained at a target oil temperature for a second predetermined duration of time after the engine is operated at a predetermined rotations per minute.

6. The non-transitory computer-readable storage medium of claim 1, wherein one of the plurality of aerial vehicle monitor graphics is a gauge indicating a range of safe operating values for a post-start engine parameter and a range of unsafe operating values for the post-start engine parameters.

7. The non-transitory computer-readable storage medium of claim 1, further comprising instructions that when executed cause the aerial vehicle control and interface system to generate a virtual touchpad for display at the GUI, a plurality of user input controls for one or more of a speed, a heading, or an altitude of the aerial vehicle provided through corresponding finger gestures on the virtual touchpad when the second plurality of operational criteria satisfied by verified post-start engine parameters.

8. The non-transitory computer-readable storage medium of claim 1, further comprising instructions that when executed further cause the aerial vehicle control and interface system to:
generate a remote assistance request control for display at the GUI, the aerial vehicle communicatively coupled to a ground-based computer system that remotely accesses input controls of the GUI.

9. The non-transitory computer-readable storage medium of claim 1, wherein the aerial vehicle is a rotorcraft.

10. The non-transitory computer-readable storage medium of claim 1, wherein the plurality of pre-start engine parameters include one or more of a seat belt lock state, a fuel valve state, a brake engagement state, a circuit breaker state, or a freedom of movement state.

11. The non-transitory computer-readable storage medium of claim 1, wherein the plurality of post-start engine parameters include one or more of an engine torque, a rotational speed of an engine compressor, or a measured gas temperature.

12. The non-transitory computer-readable storage medium of claim 1, further comprising instructions that when executed further cause the aerial vehicle control and interface system to:
generate a plurality of manually verified engine start controls including input controls to provide user verification of one or more of a clear area around the aerial vehicle, a fuel-pull off guard is on, a cabin heat is off, or a rotor brake is off.

13. The non-transitory computer-readable storage medium of claim 1, wherein the instructions when executed further cause the aerial vehicle control and interface system to:
perform a set of pre-start engine checks, the plurality of pre-start engine parameters characterizing outcomes of the performed set of pre-start checks; and
perform a set of post-start engine checks, the plurality of post-start engine parameters characterizing outcomes of the performed set of post-start checks.

14. The non-transitory computer-readable storage medium of claim 1, wherein the instructions when executed further cause the aerial vehicle control and interface system to, in response to determining that the second plurality of operational criteria are not satisfied by the verified post-start engine parameters, stop the engine.

15. A method comprising:
generating a graphical user interface (GUI) comprising a plurality of aerial vehicle monitor graphics providing an operator of an aerial vehicle with status information related to operations of the aerial vehicle;
measuring a plurality of pre-start engine parameters using one or more of a plurality of sensors coupled to the aerial vehicle;
generating a first status indicator for display at the GUI indicating that an engine of the aerial vehicle is ready to be started if determined that a first plurality of operational criteria are satisfied by the plurality of pre-start engine parameters;
in response to starting the engine of the aerial vehicle, for each computer of a plurality of computers:
measuring a post-start engine parameter using a sensor of the plurality of sensors coupled to the aerial vehicle;
verifying that the measured post-start engine parameters satisfy one or more accuracy criteria; and
modifying one or more of the plurality of aerial vehicle monitor graphics of the GUI to reflect the verified post-start engine parameters; and
generating a second status indicator for display at the GUI indicating that the aerial vehicle is ready for flight in response to determining that a second plurality of operational criteria are satisfied by the verified post-start engine parameters.

16. The method of claim 15, further comprising:
in response to the second plurality of operational criteria satisfied by verified post-start engine parameters:
generating a virtual touchpad for display at the GUI, a plurality of user input controls for one or more of a speed, a heading, or an altitude of the aerial vehicle provided through corresponding finger gestures on the virtual touchpad.

17. The method of claim 15, further comprising:
generating a plurality of manually verified engine start controls including input controls to provide user verification of one or more of a clear area around the aerial vehicle, a fuel pull-off guard is on, a cabin heat is off, or a rotor brake is off.

18. An aerial vehicle control and interface system comprising:
a universal vehicle control interface for an aerial vehicle, the universal vehicle control interface configured to:
receive input commands from an operator of the aerial vehicle; and
display a graphical user interface (GUI) comprising a plurality of aerial vehicle monitor graphics providing the operator with status information related to operations of the aerial vehicle; and
a universal avionics control router configured to:
measure a plurality of pre-start engine parameters using one or more of a plurality of sensors coupled to the aerial vehicle;
generate a first status indicator for display at the GUI indicating that an engine of the aerial vehicle is ready to be started if determined that a first plurality of operational criteria are satisfied by the plurality of pre-start engine parameters; and
in response to starting the engine of the aerial vehicle, for each computer of a plurality of computers:
measure a post-start engine parameter using a sensor of the plurality of sensors coupled to the aerial vehicle;
determine a plurality of verified post-start engine parameters by verifying that the measured post-start engine parameters satisfy one or more accuracy criteria;
modify one or more of the plurality of aerial vehicle monitor graphics of the GUI to reflect a plurality of verified post-start engine parameters; and
generate a second status indicator for display at the GUI indicating the aerial vehicle is ready for flight in response to determining that a second plurality of operational criteria are satisfied by the plurality of verified post-start engine parameters.

19. The aerial vehicle control and interface system of claim 18, wherein the universal avionics control router is further configured to:
in response to the second plurality of operational criteria satisfied by the verified post-start engine parameters:
generate a virtual touchpad for display at the GUI, a plurality of user input controls for one or more of a speed, a heading, or an altitude of the aerial vehicle provided through corresponding finger gestures on the virtual touchpad.

20. The aerial vehicle control and interface system of claim 18, wherein the universal avionics control router is further configured to:
generate a plurality of manually verified engine start controls including input controls to provide user verification of one or more of a clear area around the aerial vehicle, a fuel pull-off guard is on, a cabin heat is off, or a rotor brake is off.
